(19) United States
(12) Patent Application Publication
(10) Pub. No.: US 2009/0253490 A1
(43) Pub. Date: Oct. 8, 2009

(54) Gaming Machine Having Questionnaire Function And Control Method Thereof

(75) Inventor: Tatsuya TERANISHI, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Gaming America, Inc., Las Vegas, NV (US)

(21) Appl. No.: 12/418,296

(22) Filed: Apr. 3, 2009

Related U.S. Application Data
(60) Provisional application No. 61/042,025, filed on Apr. 3, 2008.

(51) Int. Cl. A63F 9/24; A63F 13/00

(52) U.S. Cl. 463/20; 463/30; 463/43

(57) ABSTRACT

A gaming machine of the present invention includes: a controller which executes a process of starting a game, as triggered by establishment of a predetermined condition, a process of counting the number of times of executing the game, and a process of judging whether or not the counted number of times of executing the game has reached a predetermined value; a display device which is capable of displaying a question to be answered, in a case where the controller judges that the number of times of executing the game has reached a predetermined value; an input device for inputting an answer to the question displayed on the display device; a memory which stores the answer and game history input through the input device and plural types of video data and audio data; and a reproduction device which reproduces video data and audio data selected according to the stored answer and game history.

### CROSS-REFERENCE TO RELATED APPLICATIONS

This application claims priority of U.S. Provisional Application No. 61/042,025 filed on Apr. 3, 2008. The contents of this application are incorporated herein by reference in their entirety.

### BACKGROUND OF THE INVENTION

1. Technical Field

The present invention relates to a gaming machine having a questionnaire function and a control method thereof.

2. Description of the Related Art

Conventionally, in gaming facilities in which gaming machines such as slot machines are installed, players can enjoy games by inserting a variety of gaming mediums such as coins and cashes. Each of the gaming machines is designed so as to pay out a payment according to a winning prize (game outcome) that takes place in the progress of a game.

In a casino in which a plurality of slot machines are installed, there is a so called “jackpot” from which, after part of the credit consumed in each of the slot machines has been reserved, if the amount of the reservation reaches a predetermined amount of money, a large amount of payout is made such that a payment is not paid out to any of the slot machines in an ordinary hit (see Published US Patent Application No. 2003/073486, for example). In such slot machines, in the ordinary case, a hit takes place at each of the set probabilities, and players conduct games while anticipating the hit. By means of a lottery other than that of the ordinary hit, which is based upon each of the probabilities set in the slot machines, a jackpot hit will take place on any of the slot machines with a predetermined timing. Further, in order to pay out a large amount of money at the time of establishment of “jackpot”, in general, a plurality of casinos are interconnected via a network.

A system in which a host computer and a plurality of gaming machines are connected via a network and the host computer controls an occurrence of a bonus at the gaming machines is also disclosed (refer to U.S. Pat. No. 5,820459, for example). In this system, the host computer integrates the number of coin insertions at each of the gaming machines, and integrates part of the number of coin insertions at the plurality of gaming machines as a bonus pool. Further, the host computer imparts a bonus qualification to a gaming machine at which the number of coin insertions has reached a predetermined number. When a value of the bonus pool has reached a predetermined threshold value, the host computer transmits a command to one gaming machine selected from among the gaming machines to which bonus qualification has been imparted. At the gaming machine having received the above command, a bonus game with its high gambling feature is performed.

However, information which is acquirable in the conventional slot machines or host computer is objective information pertinent to games such as game counts, accumulative number of coin insertions, integral values of bonus pools, accumulative amounts of payouts, profits and deficits, or return rates; and subjective information, i.e., what players felt about games could not be obtained. Therefore, the conventional gaming machines entail a problem insofar that, in seeking to obtain the players' impressions or evaluations of games performed at slot machines and gaming facilities on which the slot machines are installed, there is a need to make a market research for; and it takes a plenty of time to obtain a result of the research, further resulting in very high human cost.

The present invention has been made in view of the abovementioned circumstance and aims to provide a gaming machine and control method of the gaming machine which is capable of collecting, in a short time, players' actual opinions of advantages and drawbacks of games, etc., which the players felt.

### SUMMARY OF THE INVENTION

A first aspect of the present invention is directed to a gaming machine, including: a controller which executes a process of starting a game, as triggered by establishment of a predetermined condition; a display device which displays a question to be answered; an input device for inputting an answer to the question displayed on the display device; and a memory which stores the answer input through the input device.

According to the aforementioned gaming machine, games are started where a predetermined condition is met. Such games include: a base game in which gaming mediums are betted, symbols are rearranged on the display device, and a payment is made according to a combination of the rearranged symbols; a free game executed without gaming mediums being betted; and a common game in which players at gaming machines participate simultaneously. Answers to questions displayed on the display device are input through the input device, and the input answers are stored in a memory.

The questions to be answered include the player's age, gender, impression or evaluation of games, and impression or evaluation of gaming facilities in which gaming machines are installed. The above questions are displayed on the display device. Answers to these questions are obtained from players, whereby information pertinent to the players such as ages and genders or actual opinions of the players such as advantages and drawbacks of games felt by the players can be collected within a short period of time without making a market research for.

A second aspect of the present invention is directed to the gaming machine, further including: a memory which stores plural types of video data and audio data; and a reproduction device which reproduces video data and audio data selected according to the stored answer.

According to the abovementioned gaming machine, images or music according to the players' answers are reproduced. Therefore, images and music, which are different depending upon the players' ages or genders, can be reproduced, and the interests or concerns of the players who are performing games can be continuously maintained.

A third aspect of the present invention is directed to the gaming machine, further including a communication interface connected to a counting server which counts the answer to the question, wherein: the communication interface transmits the answer input through the input device to the counting server together with identification information for identifying a transmission source.

According to the abovementioned gaming machine, the answers obtained by the gaming machine are collected by the counting server. Therefore, information pertinent to the players such as ages or genders and actual opinions of the players such as advantages or drawbacks of garies felt by the players can be collected without making a market research for. Further, when the answers are transmitted to the counting server, identification information for identifying transmission sources such as ID codes for identifying gaming machines or those of gaming facilities in which the gaming machines are installed is transmitted. Thus, information pertinent to the players or impression or evaluation of games can be counted for each gaming facility or for each gaming machine. Moreover, the gaming machines are replaced or the contents of games are changed based upon the counting result, whereby the ability to attract customers can be enhanced more remarkably.

A fourth aspect of the present invention is directed to the gaming machine, wherein: the controller executes a process of counting the number of times of executing the game and a process of judging whether or not the counted number of executing the game has reached a predetermined value; and the display device is capable of displaying a question to be answered, in a case where the controller judges that the number of times of executing the game has reached a predetermined value.

According to the abovementioned gaming machine, only when the number of times of executing games has reached a predetermined value, questions to be answered are displayed on the display device. Therefore, answers from players who have not actually performed games or answers from players with a small number of times of executing games can be excluded from the counting. For example, when the display device displays questions to be answered, such as questions relevant to impression or evaluation of games or impression or evaluation of gaming facilities in which gaming machines are installed, the reliability of answers to these questions is enhanced.

A fifth aspect of the present invention is directed to the gaming machine, wherein: the controller executes a process of associating the answer input through the input device with a game history obtained until a question has been displayed on the display device, and then, storing the answer and game history in the memory.

According to the abovementioned gaming machine, the answers input through the input device and the game history are stored in association with each other. The answers and the game history are associated with each other, thus making it possible to grasp a correlation between information including the players' ages, genders, and impressions or evaluations of games and the game history such as the number of times of executing games or acquired prize money.

A sixth aspect of the present invention is directed to the gaming machine, further including: a memory which stores plural types of video data and audio data; and a reproduction device which reproduces video data and audio data selected according to the stored answer and game history.

According to the abovementioned gaming machine, the image or music according to the players' answers and game history is reproduced. Therefore, the images and music different depending upon the players' ages or genders can be reproduced, and the interest or concern of the players who are performing games can be continuously maintained. If more games are executed or if more prize money are acquired, privileged image and privileged music can be reproduced, making the players feel more enjoyable.

A seventh aspect of the present invention is directed to a gaming machine, including: a controller which executes a process of starting a game, as triggered establishment of a predetermined condition, a process of counting the number of times of executing the game, and a process of judging whether or not the counted number of times of executing the game has reached a predetermined value; a display device which is capable of displaying a question to be answered, in a case where the controller judges that the number of times of executing the game has reached a predetermined value; an input device for inputting an answer to the question displayed on the display device; a memory which stores the answer and game history input through the input device and plural types of video data and audio data; and a reproduction device which reproduces video data and audio data selected according to the stored answer and game history.

According to the abovementioned gaming machine, games are started in a case where a predetermined condition is met. Such games include: a base game in which, after gaming mediums are betted, for example, symbols are rearranged on the display device, and then, a payment is made in accordance with a combination of the rearranged symbols; a free game performed without gaming mediums being betted; and a common game in which the players at gaming machines participate simultaneously. Further, the answers to questions displayed on the display device are input through the input device, and then, the input answers are stored in the memory.

The questions to be answered include the player's age, gender, impression or evaluation of games, and impression or evaluation of gaming facilities in which gaming machines are installed. The above questions are displayed on the display device. Answers to these questions are obtained from players, whereby information pertinent to the players such as ages and genders or actual opinions of the players such as advantages and drawbacks of games felt by the players can be collected within a short period of time without making a market research for.

According to the abovementioned gaming machine, only when the number of times of executing games has reached a predetermined value, questions to be answered are displayed on the display device. Therefore, answers from players who have not actually performed games or those from players who have executed games a small number of times can be excluded from the counting. For example, when the display device displays questions to be answered, such as questions relative to impression or evaluation of games or those relative to impression or evaluation of gaming facilities in which gaming machines are installed, the reliability of answers to these questions is enhanced.

According to the abovementioned gaming machine, the answers input through the input device and the game history are stored in association with each other. This makes it possible to grasp a correlation between information including the players' ages, genders, and impressions or evaluations of games and the game history such as the number of times of executing games or acquired prize money. Further, the images and music, which are different depending upon the players' ages or genders, can be reproduced, and the interests or concerns of the players who are performing games can be continuously maintained. If more games are executed or if more prize money are acquired, privileged image and privileged music can be reproduced, making the players feel more enjoyable.

An eighth aspect of the present invention is directed to a control method, including the steps of: starting a game, as triggered by establishment of a predetermined condition; displaying a question to be answered, on a display device; and storing in a memory the answer input through an input device in response to the displayed question.

According to the abovementioned control method, games are started in a case where a predetermined condition is met. Such games include: a base game in which, after gaming mediums are betted, for example, symbols are rearranged on the display device, and then, a payment is made in accordance with a combination of the rearranged symbols; a free game is performed without gaming mediums being betted; and a common game in which the players at gaming machines participate simultaneously. Further, the answers to questions displayed on the display device are input through the input device, and then, the input answers are stored in the memory.

The questions to be answered include the player's age, gender, impression or evaluation of games, and impression or evaluation of gaming facilities in which gaming machines are installed. The above questions are displayed on the display device. Answers to these questions are obtained from players, whereby information pertinent to the players such as ages and genders or actual opinions of the players such as advantages and drawbacks of games felt by the players can be collected within a short period of time without making a market research for.

### BRIEF DESCRIPTION OF THE DRAWINGS

FIG. 1 is an explanatory view of a questionnaire screen displayed by a gaming machine according to the present embodiment;

FIG. 2 is an explanatory view of processing operations of a gaming system according to the embodiment;

FIG. 3 is a perspective view schematically showing a gaming machine;

FIG. 4 is an explanatory view of a payout table in the embodiment;

FIG. 5 is a block diagram depicting an interior configuration of the gaming machine;

FIG. 6 is a block diagram depicting an interior configuration of a common display device;

FIG. 7 is a schematic view showing an answer-to-questionnaire screen;

FIG. 8 is a schematic view showing an answer-to-questionnaire screen;

FIG. 9 is a schematic view showing an answer-to-questionnaire screen;

FIG. 10 is a flowchart showing procedures for executing main processing at the gaming machine;

FIG. 11 is a flowchart showing procedures for executing main processing at the gaming machine;

FIG. 12 is a tabulated view showing a relationship between the player's age and video data and audio data to be selected;

FIG. 13 is a view showing exemplary images displayed on the upper and lower image display panels in the insurance-off mode;

FIG. 14 is a view showing exemplary images displayed on the upper and lower image display panels in the insurance-off mode;

FIG. 15 is a view showing exemplary images displayed on the upper and lower image display panels in the insurance-on mode;

FIG. 16 is a flowchart showing procedures for performing games during the insurance-on mode;

FIG. 17 is a flowchart showing procedures for performing games during the insurance-on mode;

FIG. 18 is a schematic view showing an exemplary counting database included in a counting server;

FIG. 19 is a flowchart showing procedures for executing single-game processing;

FIG. 20 is a flowchart showing procedures for determining symbols to be stopped;

FIG. 21 is a flowchart showing procedures for executing reel rotation control processing;

FIGS. 22A to 22D are explanatory side views of reel rotating movement;

FIG. 23 is a schematic view showing a correlation table between the number of steps and code Nos.; and

FIG. 24 is a flowchart showing procedures for performing startup processing.

### DESCRIPTION OF THE PREFERRED EMBODIMENTS

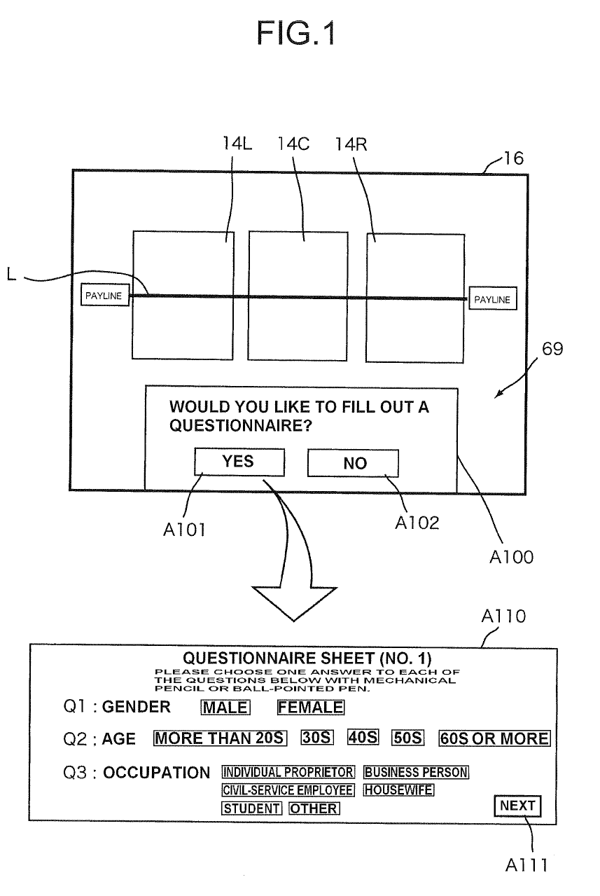

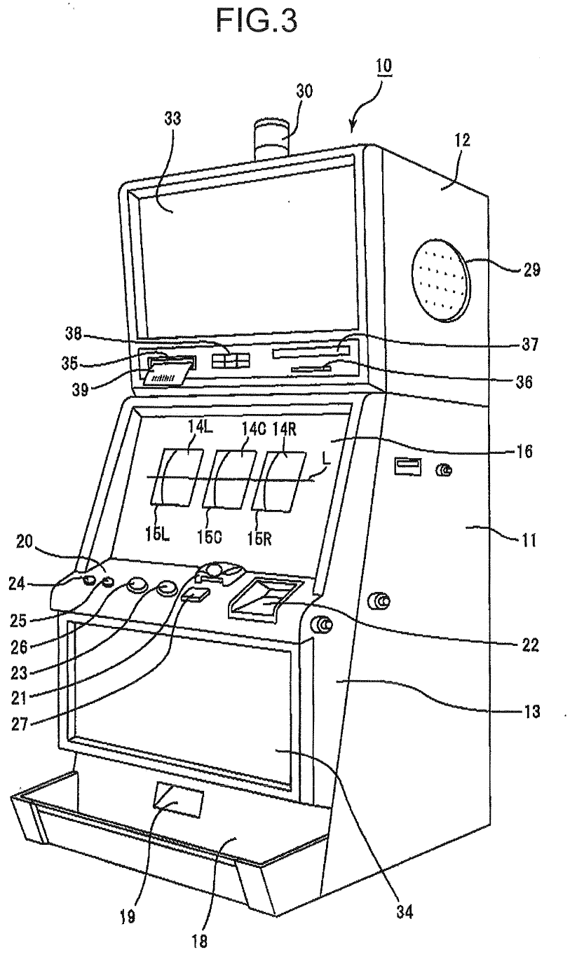

Hereinafter, embodiments of the present invention will be described in detail, referring to the drawings. FIG. 1 is an explanatory view of a questionnaire screen displayed by a gaming machine according to the present embodiment. In the embodiment, a gaming machine 10 serves as a slot machine (see FIG. 3). The gaming machines are not limitative to slot machines, and may be so called single game machines such as video stop machines or video card game machines or may be so called multi-players gaming machines (multi-terminal gaming machines) which perform games requiring a predetermined time until a result is displayed such as a horserace game, a bingo game, or a lottery.

In the gaining machine 10, coins, bills, or electronic valuable information are employed as gaming mediums. In the present invention, however, medals, tokens, electronic money, or tickets, for example, may be employed as gaming mediums without being limitative thereto in particular. As the abovementioned tickets, for example, bar code-attached tickets, as will be described later, may be employed without being limitative thereto in particular.

The gaming machine 10 performs a game (That which is generally performed at slot machines. Hereinafter, referred to as a “base game”) in which, after gaming mediums equal to or smaller than a predetermined maximum BET number have been betted, a plurality of symbols are variably displayed according to reels 14 (14L, 14C, 14R) serving as symbol display devices, and then, are displayed in a stopped state, and further, a payment amount is determined depending upon the symbols displayed in a stopped state on a payline L or a combination thereof.

Moreover, an insurance-off mode is transferred to an insurance-on mode on condition that a predetermined number (1, in the embodiment) of gaming mediums has been entered. If the number of times of executing all of the base games performed after transfer to the insurance-on mode (hereinafter, referred to as total game count C) reaches a predetermined number (second predetermined value Th2, for example, 1,000 times), a predetermined number of gaming machines (360 in the embodiment) is paid, and a free game is performed.

The free game is performed even if no gaming mediums are betted. In this game, a plurality of symbols is variably displayed on reels 14, and thereafter, the variably displayed symbols are displayed in a stopped state according to the symbols displayed in a stopped state or a combination thereof. Further, the amount of payment is determined according to the symbols displayed in a stopped state or a combination of the displayed symbols. In other words, the free games, the contents of which are identical to those of base games, are performed even if no gaming medium is betted. The free games may be performed by a predetermined number of times (for example, 100 times), or alternatively, may be varied according to the game history of the base game.

The gaming system 100 according to the embodiment performs countdown effect rendering on both of the gaming machines 10 and the common display device 200 until the free game is started, in order to enhance anticipation or excitement of the players relative to the free games. This countdown effect rendering is performed if the number of times of executing base games reaches a specific number of times (a first predetermined value Th1, for example, 990 times).

Specifically, if countdown effect rendering is performed at the gaming machine 10, the corresponding countdown effect image (or video image) is displayed on a display device provided at the gaming machine 10 (upper image display panel 33 shown in FIG. 3).

The gaming machine 10 is designed to count the number of times of executing a base game. Further, this gaming machine is constituted to display a questionnaire screen for acquiring information pertinent to players per se and evaluations or impressions relative to the contents of games or gaming facilities on a lower image display panel 16, after the counted number of times of executing the base game has reached a predetermined value. While the number of times of executing the base game for displaying the questionnaire screen may be arbitrarily set, the predetermined value is set to 1,000 (i.e., a second predetermined value Th2) in order to perform a questionnaire after the completion of a free game, in the present embodiment.

A touch panel 69 serving as an input device of the present invention is provided on a front face of the lower image display panel 16. This panel allows players to make entries of various instructions in the play of a game or answers to questionnaires by way of their depressing operation on the touch panel 69.

In the embodiment, after the number of times of executing the base game has reached a first predetermined value, in a case where a free game is performed, an answer request screen A100 as shown in FIG. 1 is displayed on the lower image display panel 16 in order to prompt players for answers to questionnaires. On this answer request screen A100, a message prompting players to answer questionnaires is displayed, and an answer acceptance button A101 and an answer rejection button A102, which function as operational input sections on the touch panel 69, are disposed.

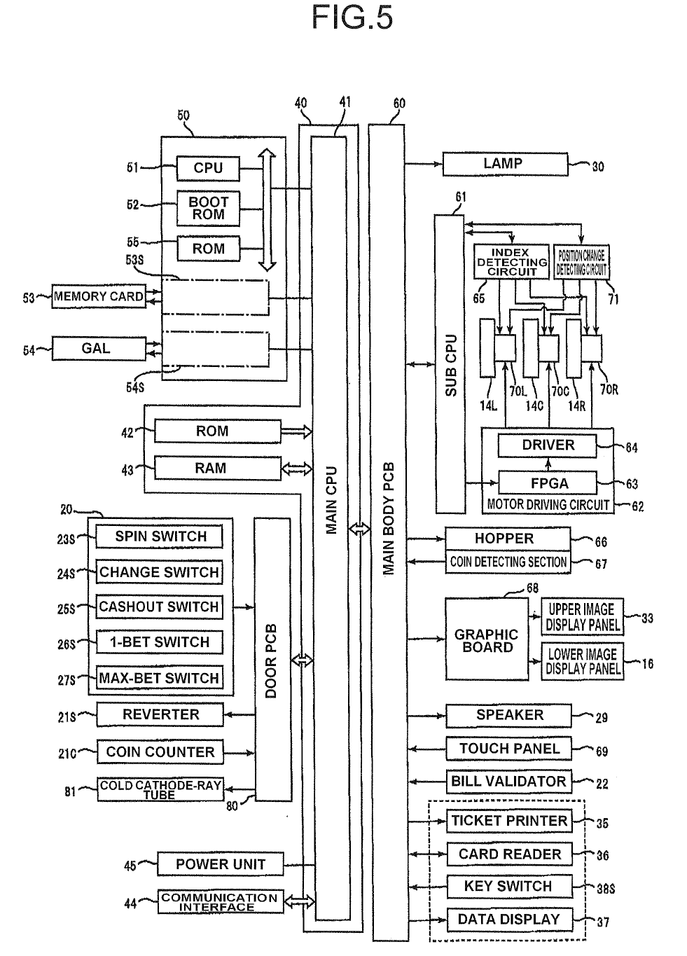

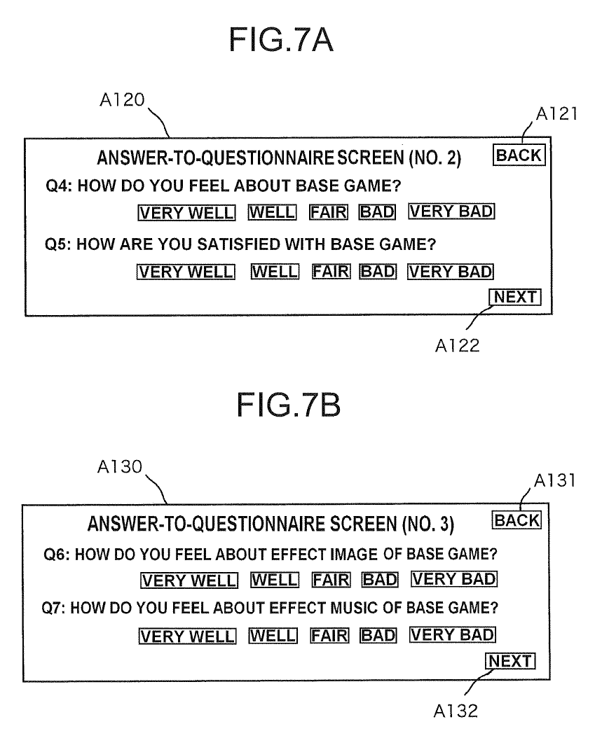

On the answer request screen A100, when a player depresses the answer acceptance button A101, the gaming machine 10 causes the lower image display panel 16 to display the answer-to-questionnaire screen A110, as shown in FIG. 1, after changed from the answer request screen A100. This answer-to-questionnaire screen A110 displays questions of asking about the player's gender, age, and occupation, and a plurality of input buttons are disposed which are indicated in rectangular areas in order to accept answers to these questions. For example, two input buttons are disposed, one of which is indicated in a rectangular area surrounding letters “Male” in order to accept an answer “Male” and the other one of which is indicated in a rectangular area surrounding letters “Female” in order to accept an answer “Female” to question Q1 asking about gender. This also applies for question Q2 asking about age and question Q3 asking about occupation. Where a player depresses either of these input buttons, the depressed input button is displayed in a reverse video, for example, so that the player can visually recognize the selection. The input answers are stored in memory incorporated in equipment (RAM 43 described in FIG. 5). Depressing a next-page button A111 disposed in a lower area of the answer-to-questionnaire screen 110A displays a next questionnaire screen (questionnaire screen A120 shown in FIG. 7A) on the lower image display panel 16.

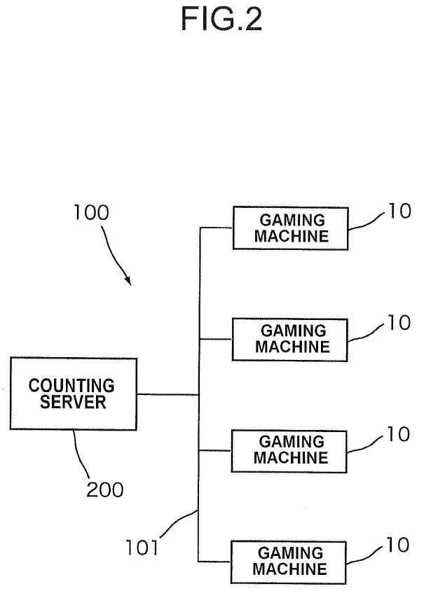

FIG. 2 is an explanatory view explaining processing operations of a gaming system according to the embodiment. A gaming system 100 according to the embodiment is provided with: a plurality of gaming machines 10; and a counting server 200 connected to these gaming machines 10 via a communication line 101. Such gaming system 100, which is capable of performing a variety of games, may be constructed in one gaming facility such as bar parlor or casino, or alternatively, may be constructed among a plurality of gaming facilities. The gaming system 1 may be constructed in one gaming facility on a floor-by-floor basis or on a section-by-section basis in the gaming facility.

The gaming machines 10 are assigned unique ID numbers (hereinafter, referred to as gaming machine ID numbers) and those of gaming facilities in which the gaming machines 10 are installed (hereinafter, referred to as “gaming facility Nos.”). Further, the counting server 200 discriminates a source of data sent from each of the gaming machines 10 in accordance with the gaming machine ID numbers and gaming facility Nos. The data that each of the gaming machines 10 transmits to the counting server 200 include players' answers obtained through the answer-to-questionnaire screen or the like. Where the counting server 200 transmits data to the gaming machine 10 as well, a transmission destination is specified using the gaming machine ID numbers and gaming facility Nos. The information for identifying gaming machines and gaming facilities can include letters, signs, numerals and a combination thereof, in addition to the ID numbers.

FIG. 3 is a perspective view schematically showing a gaming machine 10. The gaming machine 10 is provided with: a cabinet 11; a top box 12 set up on the upper side of the cabinet 11; and a main door 13 provided on the front face of the cabinet 11. Three reels 14 (14L, 14C, 14R) are rotatably provided inside of the cabinet 11. A symbol array consisting of 22 pictures (hereinafter, referred to as symbols) is drawn on the outer periphery of each of the reels 14.

A lower image display pane 16 is provided in front of each of the reels 14 at a main door 13. The lower image display panel 16 is provided with a transparent liquid crystal display panel on which a variety of images or effect images, etc., pertinent to games are displayed during the play of the games. A credit amount display section 31 and a payout number display section 32 are set on the lower image display panel 16. The credit amount display section 31 displays the number of credited coins by way of image. The payout number display section 32 displays, by way of image, the number of coins to be paid out if a predetermined combination of symbols is displayed in a stopped state on a payline L.

On the lower image display panel 16, three display windows 15 (15L, 15C, 15R) are formed which are capable of visually recognizing a rear face of the display panel, and the symbols drawn on the outer periphery of the reels 14 via the display windows 15 are displayed on a three-by-three symbols basis. On the lower image display panel 16, one payline horizontally crossing the three display windows 15 is formed. The payline L defines a combination of symbols. If a predetermined combination of symbols is displayed in a stopped state on the payline L, coins are paid out, the number of which corresponds to the predetermined combination and the number of inserted coins (BET number).

In the present invention, for example, where a plurality of paylines L horizontally or obliquely crossing the three display windows 15, for example, is formed, the paylines L are activated, the number of which corresponds to that of inserted coins, and then, a predetermined combination of symbols is displayed in a stopped state, coins of which the number corresponds to the predetermined combination may be paid out.

Further, a touch panel 69 is provided on the front face of the lower image display panel 16. This panel allows players to operate the touch panel 69 and enter various instructions in games or answers to questionnaires.

Downwardly of the lower image display panel 16, a control panel 20 consisting of a plurality of buttons 23 to 27 for entering instructions pertinent to the progress of a game by a player; a coin insertion slot 21 for accepting coins in the cabinet 11; and a bill validator 22 are provided.

A SPIN button 23, a CHANGE button 24, a CASHOUT button 25, a 1-BET button 26, and a MAX-BET button 27 are provided on the control panel 20. A SPIN button 23 is for entering an instruction for starting rotation of the reels 14. The change button 24 is intended for use in asking an attendant of the gaming facility for change. The CASHOUT button 25 is intended to enter an instruction for paying out credited coins to the coin tray 18.

The 1-BET button 26 is intended to enter an instruction for betting one of the credited coins on a game. The MAX-BET button 27 is intended to enter an instruction for betting the maximum number of credited coins (50 coins in the embodiment) that can be betted on one game.

In the present invention, insertion of gaming mediums denotes that gaming mediums are consumed. The gaming mediums are consumed where they are betted on a game and where they are consumed to migrate to an insurance-on mode to be described later. For example, if the coins inserted into the coin insertion slot 21 are directly betted on a game, the coin insertion into the coin insertion slot 21 is equivalent to gaming medium insertion. As in the present invention, however, if coins are temporarily credited after being inserted into the coin insertion slot 21 and if the credited coins are betted by operating the 1-BET button 26 or the MAX-BET button 27, such betting is equivalent to gaming medium insertion.

A bill validator 22 validates legitimacy of bills and accepts legitimate bills in the cabinet 11. The bill validator 22 may be constituted so as to enable reading of a bar code-attached ticket 39 to be described later. On the lower front face of the main door 13, i.e., downwardly of the control panel 20, a belly glass 34 is provided on which animation characters or the like of the gaming machine 10 are drawn.

An upper image display panel 33 is provided on the front face of the top box 12. The upper image display panel 33 is provided with a liquid crystal panel, and, for example, images are displayed which is indicative of an introduction to effect images or the contents of games and an explanation of the rules of the games.

A speaker 29 is provided on the top box 12. A ticket printer 35, a card reader 36, a data display 37, and a keypad 38 are provided at the lower side of the upper image display panel 33. The ticket printer 35 prints, on tickets, bar codes containing coded data such as credit amount, date and time, or ID numbers of the gaming machine 10, and the bar code-attached tickets 39 are output. A player can cause another gaming machine to read the bar code-attached ticket 39, thereby performing a game at the gaming machine or to exchange the bar code attached-ticket 39 with bills or the like at a predetermined site of a gaming facility (for example, at a casher in casino).

The card reader 36 is intended to read and write data from/into a smart -card. The smart card is owned by a player, and stores data for identifying a player or data pertinent to a history of games performed by players, for example. The smart card may store data equivalent to coins, bills, or credits. In place of the smart card, further, a magnetic stripe card may be employed. The data display 37 is made up of a fluorescent display or the like, and stores data read by the card reader 36 or data input by a player via the keypad 38, for example. The keypad 38 is intended for entering the instructions or data pertinent to the issuance of tickets.

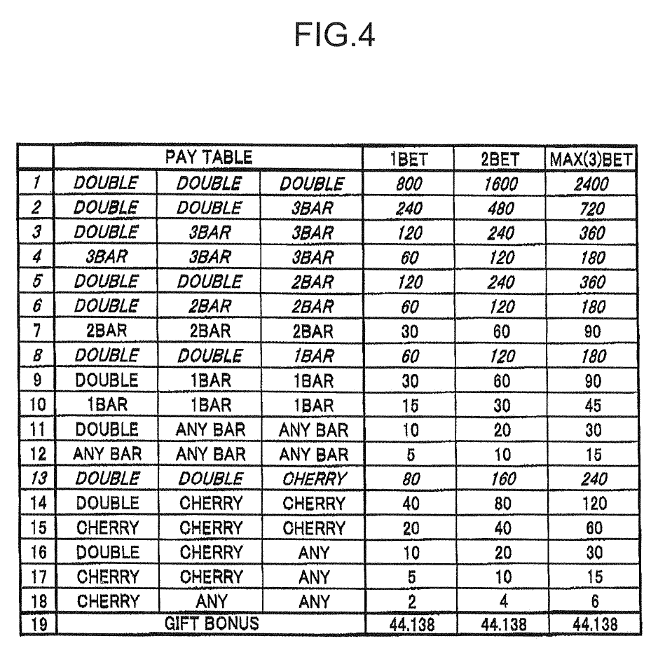

FIG. 4 is an explanatory view of a payout table in the embodiment. “DOUBLE”, “3BAR”, “2BAR”, “1BAR”, and “CHERRY” contained in the payout table indicate types of symbols drawn on each of the reels 14. In addition to the abovementioned symbols, a bonus trigger which is a winning combination of symbols corresponding to “GIFT BONUS” and any other symbol are also drawn on each of the reels 14. “ANY BAR” contained in the payout table indicates “3BAR”, “2BAR”, or “1BAR”, and “ANY” denotes any symbol.

Combinations of the symbols shown in the payout table denote winning combinations, and the payout number of coins according to a BET number is set for each of the combinations. If a combination of the symbols displayed in a stopped state on each of the reels 14 is that of the bonus triggers of “GIFT BONUS”, a predetermined number of coins are paid out as a jackpot. The numerical values corresponding to “GIFT BONUS” described on the payout table denote expectation values of the coin payout numbers, and are uniform irrespective of the BET numbers. If the number of bets is 1BET, therefore, settings are provided such that a probability of “GIFT BONUS” is low and a large number of coins are paid out. This probability is set according to symbol-weighted data.

Four different types of jackpots “GRAND”, “MAJOR”, “MINOR”, and “MINI” are provided in sequential order from the largest payout number of coins. The lower probabilities of occurrence of these jackpots are set, as the larger the payout number of coins is, and which one of the jackpots is established is randomly determined using random number values. The expectation values of the coin payout numbers in the jackpots are uniform.

After the 1-BET button 26 or the MAX-BET button 27 has been depressed, when a SPIN button 23 is depressed to start a game, the columns of the symbols drawn on each of the reels 14 are displayed in a scrolled-down manner, together with rotation of each of the reels 14. After an elapse of a predetermined time, these columns of the symbols are displayed in a stopped state on the display window 15, together with rotation stop of each of the reels 14. Further, if a variety of winning combinations is predetermined based upon combinations of the symbols, and then, a combination of the symbols corresponding to one of these winning combinations is stopped on a payline L, the payout number of coins corresponding to the winning combination is added to the player-owned credit. When a combination of “GIFT BONUS” bonus triggers is realized, a predetermined payout number is added to the player-owned credit.

The present embodiment describes a case in which a jackpot-based coin payout is made when a combination of bonus triggers is realized. In the present invention, however, a game-playing state, which is established when the combination of the bonus triggers is realized, is not limitative in particular, and games such as a second game and a mystery bonus game can be performed, for example. When the bonus trigger combination is realized, a bar code-attached ticket 39 on which the predetermined information was printed may be issued.

In the payout table, combinations of the symbols indicated by italics are those in which 180 or more coins are paid out when they are realized in a game performed by MAX-BET. In the game performed by MAX-BET in an insurance-on mode, if any one of these symbol combinations is realized, the insurance-on mode migrates to the insurance-off mode.

FIG. 5 is a block diagram depicting an interior configuration of a gaming machine 10. A gaming board 50 is provided with: a CPU (Central Processing Unit) 51 interconnected via an internal bus; a ROM 55 and a boot ROM 52; a card slot 53S corresponding to a memory card 53; and an IC socket 54S corresponding to a GAL (Generic Array Logic) 54.

The memory card 53 is made up of a nonvolatile memory such as CompactFlash (registered trademark), and stores game programs and game system programs. The game programs include a stopped-symbol determination program. The stopped-symbol determination program is intended to determine symbols of each of the reels 14, which are displayed in a stopped state on the payline L (code No. corresponding to symbols). The above stopped-symbol determination program includes symbol-weighted data corresponding to each of a plurality of payout rates (80%, 84%, 88%, for example). The symbol-weighted data is indicative of a correspondence relationship between code Nos. of symbols (see FIG. 3) and one or more random number values belonging to a predetermined numeric range (0 to 256). The payout rates are determined based upon the payout rate setting data that is output from the GAL 54, and a lottery is performed based upon the symbol-weighted data corresponding to the payout rates.

In addition, a card slot 53S is constituted to enable removable insertion of the memory card 53, and the card slot is connected to a motherboard 40 by means of an IDE bus. Therefore, the memory card 53 is removed from the card slot 53S, other game programs and game system programs are written into the memory card 53, and thereafter, the memory card 53 is inserted into the card slot 53S, thereby making it possible to vary the kinds or contents of the games performed at the gaming machine 10. Further, the memory card 53 storing one group of game programs and game system programs is replaced with that storing another group of game programs and game system programs, thereby making it possible to vary the kinds or contents of the games performed at the gaming machine 10. The game programs include those which are relevant to the operating procedures for performing games. Further, they also include video data or sound data output during the play of a game and video data or sound data for notifying a transfer to the insurance-on mode.

The GAL 54 is a kind of PLD having an OR-fixed arrayed structure. The GAL 54 is provided with a plurality of IN ports and OUT ports. If predetermined items of data are input to the IN port, the corresponding data is output from the OUT port. The data output from the OUT port is equivalent to the above-described payout rate setting data. Further, the IC socket 54S is constituted so as to removably mount the GAL 54, and is connected to the motherboard 40 via the PCI bus. Therefore, the GAL 54 is removed from the IC socket 54S, programs stored in the GAL 54 are rewritten. After that, the GAL 54 is mounted to the IC socket 54, thereby making it possible to vary payout setting data output from the GAL 54. Further, the GAL 54 is replaced with the replacement GAL 54, thereby making it possible to vary the payout rate setting data.

The CPU51, the ROM55, and the boot ROM52 interconnected via the internal bus are connected to the motherboard 40 via a PCI bus. The PCI bus not only performs signal transmission between the motherboard 40 and the gaming board 50, but also supplies power from the motherboard 40 to the gaming board 50. The ROM 55 stores country identification information and authentication programs. The boot ROM 52 stores a preliminary authentication program and a program (boot code) or the like for the CPU 51 to boot the preliminary authentication program.

The authentication program is a program (falsification check program) for authenticating game programs and game system programs. The authentication program is described along verification and certification of the fact that the game programs and game system programs targeted for authentication capturing processing are not falsified, i.e., along the procedures for authenticating the game programs and game system programs (authentication procedures). The preliminary authentication program is intended to authenticate the authentication program described above. The preliminary authentication program is described along certification of the fact that the authentication program targeted for authentication processing is not falsified, i.e., along the procedures for authenticating the authentication program (authentication procedures).

The motherboard 40 is constituted using a commercially available motherboard (printed wiring board mounting basic parts of a personal computer), and is provided with: a main CPU 41; a ROM (Read Only Memory) 42; a RAM (Random Access Memory) 43; and a communication interface 44. The main CPU 41 serves as a processor of the present invention.

The ROM 42 stores the programs and permanent data related to a BIOS (Basic Input/Output System) or the like, which is made up of memory devices such as a flash memory and executed by the main CPU 41. Executing BIOS by means of the main CPU 41 performs a predetermined process of initializing peripherals and starts an acquisition process via the gaming board 50 of the game programs and game system programs stored in the memory card 53. In the present invention, the contents of the ROM 42 may be rewritable or not.

The RAM 43 stores data and programs used when the main CPU 41 is activated. Further, the RAM 43 can store authentication programs, game programs, and game system programs read via the gaming board 50.

Further, in the RAM 43, two storage areas are provided for storing the players' answers entered through a questionnaire screen and for storing data indicative of a total game count C; and a storage area for storing data indicative of a remaining count for free game. The remaining free game count is indicative of the remaining counted number of unit free game repeated as a free game.

In the RAM 43, an area for storing an insurance-on mode flag is provided. The insurance-on mode flag is indicative of whether an insurance-on mode or an insurance-off mode is established. The insurance-on mode flag storing area consists of a predetermined bit number of storing areas, for example, and the insurance-on mode flag is set to “ON” or “OFF”, according to the contents of storage in the storing area. The insurance-on mode flag “ON” indicates an insurance-on mode and the insurance-off mode flag “OFF” indicates an insurance-off mode. Further, the RAM 43 stores the data pertinent to credit amounts and coin insertion numbers or payout numbers in one game.

The communication interface 44 is intended to make communication with the counting server 200 vie the communication line 101. The main CPU 41 transmits the players' answers entered through the questionnaire screen to the counting server 200 through the communication interface 44. The counting server 200 counts the players' answers transmitted from the gaming machines 10.

To the motherboard 40, a main body PCB (Printed Circuit Board) 60 and a door PCB 80, to be described later, is interconnected by means of a USB. Further, a power unit 45 is connected to the motherboard 40. When power is supplied from the power unit 45 to the motherboard 40, the main CPU 41 of the motherboard 40 is activated. Further, power is supplied to the gaming board 50 via the PCI bus, and then, the CPU 51 is activated.

To the main body 60 and the door PCB 80, equipment or devices are connected which generates an input signal input to the main CPU 41 and operations of which are controlled by means of a control signal output from the main CPU 41. The main CPU 41 executes the game programs and game system programs stored in the RAM 43, based upon an input signal which were input to the main CPU 41, thereby performing predetermined computation to store a result thereof to the RAM 43 or to transmit a control signal to equipment or devices in a control process relative to equipment or devices.

To the main body PCB 60, a lamp 30, a sub CPU 61, a hopper 66, a coin detection section 67, a graphic board 68, a speaker 29, a touch panel 69, a bill validator 22, a ticket printer 35, a card reader 36, a key switch 38S, and a data display 37 are connected. The lamp 30 lights in a predetermined pattern, based upon a control signal output from the main CPU 41.

A sub CPU 61 controls rotation and stoppage of reels 14 (14L, 14C, 14R). To the sub CPU 61, a motor driving circuit 62, which is provided with an FPGA (Field Programmable Gate Array) 63 and a driver 64, is connected. The FPGA 63 is an electronic circuit such as a programmable LSI, and functions as a control circuit of stepping motors 70. The driver 64 functions as an amplification circuit for amplifying pulses input to the stepping motors 70. The stepping motors 70 (70L, 70C, 70R) for rotating the reels 14 are connected to the motor driving circuit 62. Each of the stepping motors 70 is a 1-2 phase-excitation type stepping motor.

In the present invention, a stepping motor excitation system is not limitative in particular, and it is possible to employ an excitation system such as a two-phase excitation system or a one-phase excitation system, for example. A DC motor may be employed in place of the stepping motors. Where the DC motor is employed, a deviation counter, a D/A converter, and a servo amplifier are connected to a sub CPU 61 in sequential order, and thereafter, the DC motor is connected to a servo amplifier. The rotational position of the DC motor is detected by means of a rotary encoder, and then, data concerning the current rotational position of the DC motor is supplied from the rotary encoder to the deviation counter.

An index detection circuit 65 and a position change detection circuit 71 are connected to the sub CPU 61. The index detection circuit 65 detects the positions (indexes to be described later) of the reels 14 in rotation, and further, can detect step-out of the reels 14. Rotation and stoppage control of the reels 14 will be described later in detail, referring to the drawings.

The position change detection circuit 71 detects a change of a stop position of the reels 14 after rotation of the reels 14 has stopped. For example, the position change detection circuit 71 detects a change of the stop position of the reels 14 according to a case, etc., in which a player forcibly changes the stop position so as to realize a winning combination of symbols, in spite of the fact that none of the winning symbol combinations is actually realized. The position change detection circuit 71 is constituted so that the change of the stop position of the reels 14 can be detected by detecting a fin (not shown) mounted to the inside of the reels 14 at predetermined intervals.

The hopper 66 is installed in a cabinet 11, and a predetermined number of coins are paid out from the coin payout opening 19 to the coin tray 18, based upon the control signal output from the main CPU 41. A coin detection section 67 is provided inside of the coin payout opening 19, and outputs an input signal to the main CPU 41, if it is detected that a predetermined number of coins have been paid out from the coin payout opening 19.

A graphic board 68 controls the images to be displayed on the upper and lower image display panels 33 and 16, based upon the control signal output from the main CPU 41. The credit amount display portion 31 on the lower image display panel 16 displays the number of credits stored in the RAM 43 (step S114). Further, the payout number of coins is displayed at the payout number display section 32 of the lower image display panel 16. The graphic board 68 is provided with: a VDP (Video Display Processor), which generates video data, based upon the control signal output from the main CPU 41; and a video RAM, etc., which temporarily stores video data generated by the VDP. The video data used when the video data is generated by the VDP is read from the memory card 53, and thereafter, is included in the game programs stored in the RAM 43.

The bill validator 22 validates legitimacy of bills and accepts legitimate bills in the cabinet 11. Upon accepting the legitimate bills, the bill validator 22 outputs an input signal to the main CPU 41, based upon the amount of the bills. The main CPU 41 stores in the RAM 43 the amount of credits that is responsive to that of bills transmitted by the input signal.

The ticket printer 35 prints, on tickets, bar codes containing the coded data such as the credit amount, date and time, and ID number of the gaming machine 10 that are stored in the RAM 43, based upon the control signal output from the main CPU 41. Then, this ticket printer outputs the bar code-attached tickets 39. The card reader 36 reads data from a smart card, thereby transmitting the read data to the main CPU 41 or writing data into the smart card, based upon the control signal from the main CPU 41. The key switch 38S is provided at a keypad 38, and outputs a predetermined input signal to the main CPU 41 when a player operates the keypad 38. A data display 37 displays data read by a card reader 36 and data input by the player via the keypad 38, based upon a control signal from the main CPU 41.

To the door PCB 80, a control panel 20, a reverter 21S, a coin counter 21C, and a cold cathode-ray tube 81 are connected. On the control panel 20, there are provided: a SPIN switch 23S corresponding to the SPIN button; a CHANGE switch 24S corresponding to the CHANGE button 24; a CASHOUT switch 25S corresponding to the CASHOUT button 25; a 1-BET switch 26S corresponding to the 1-BET button 26; and a MAX-BET switch 27S corresponding to the MAX-BET button 27. These switches 23S to 27S output input signals to the main CPU 41 when a player operates the corresponding buttons 23 to 27.

The coin counter 21C is provided inside of the coin insertion slot 21, and validates legitimacy of the coins inserted into the coin insertion slot 21 by the player. Those other than the legitimate coins are discharged from the coin payout slot 19. The coin counter 21C also outputs an input signal to the main CPU 41 when a legitimate coin is detected.

The reverter 21S is operable based upon the control signal output from the main CPU 41. This reverter distributes, the coins recognized to be legitimate by the coin counter 21C, into a cashbox (not shown) or a hopper 66 which was installed in the gaming machine 10. In other words, if the hopper 66 is filled with coins, the legitimate coins are distributed to the cashbox by means of the reverter 21S. Otherwise, the legitimate coins are distributed to the hopper 66. The cold cathode-ray tube 81 functions as a backlight installed at the rear side of the lower and upper image display panels 16 and 33, and lights based upon the control signal that was output from the main CPU 41.

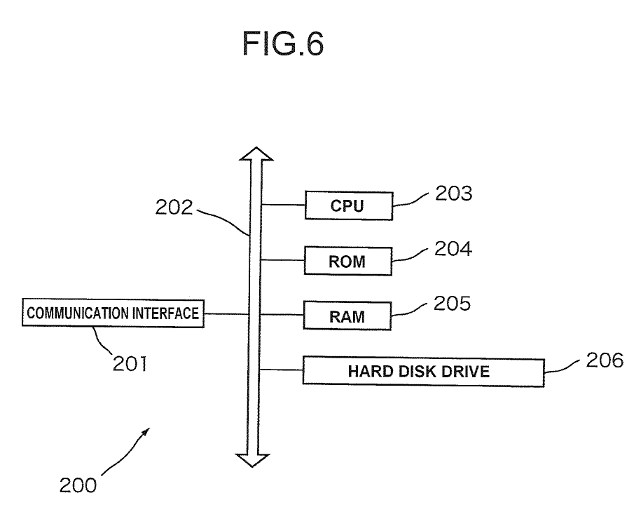

FIG. 6 is a block diagram depicting an interior configuration of a common display device 200. The counting server 200 is provided with: a CPU 203 serving as a processor; a ROM 204; a RAM 205 serving as a temporary storing device; a communication interface 201; and a hard disk drive 206. The communication interface 201 is connected to a communication interface 44 of each of the gaming machines 10. The ROM 204 stores system programs and permanent data or the like for controlling an operation of the control unit 200. The RAM 205 temporarily stores the data received from each of the gaming machines 10 or data such as a computation result. Further, the hard disk drive 206 is provided with an answer database for registering answers to questionnaires sent from the gaming machines 10.

FIGS. 7 to 9 are schematic views each showing an answer-to-questionnaire screen. The answer-to-questionnaire screen A120 shown in FIG. 7A is displayed after changed from the answer-to-questionnaire screen A110 when a next page button A111 of the answer-to-questionnaire screen A110 shown in FIG. 1 has been depressed. This questionnaire screen A120 displays question Q4 asking evaluation relative to a base game and question Q5 asking the degree of satisfaction relative to the base game. Answer buttons shown in five rectangular areas, respectively, are provided in order to accept one of the answers indicative of five levels of evaluation or satisfaction to each of the questions. When a previous page bottom A121 disposed at the upper right corner of the answer-to-questionnaire screen A120 has been depressed, the routine reverts to the answer-to-questionnaire A110 shown in FIG. 1; and when a next page button A122 disposed at the lower right corner has been depressed, an answer-to-questionnaire screen A130 shown in FIG. 7B is displayed.

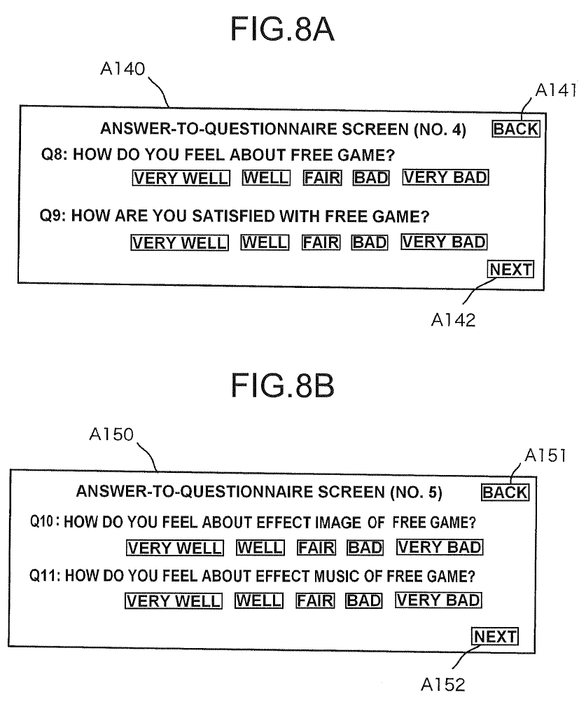

The answer-to-questionnaire screen A130 shown in FIG. 7B is displayed after changed from the answer-to-questionnaire screen A120 when the next page button A122 of the answer-to-questionnaire screen A120 shown in FIG. 7A has been depressed. This questionnaire screen A130 displays question Q6 asking evaluation relative to an effect image in a base game and question Q7 asking evaluation relative to effect music in the base game. Each of the answer buttons indicated by five rectangular areas is provided in order to accept at least one of the answers indicative of five levels of evaluation to each of the questions. When the previous page A131 disposed at the upper right corner of the answer-to-questionnaire screen A130 has been depressed, the routine reverts to the answer-to-questionnaire screen A120 shown in FIG. 7A. Alternatively, when the next page button A132 disposed at the lower right corner has been depressed, the answer-to-questionnaire screen A140 shown in FIG. 8A is displayed.

The answer-to-questionnaire screen A140 shown in FIG. 8A is displayed after changed from the answer-to-questionnaire screen A1 30 when the next page button A1 32 of the answer-to-questionnaire screen A130 shown in FIG. 7B has been depressed. This questionnaire screen A140 displays question Q8 asking evaluation relative to a free game and question Q9 asking satisfaction relative to the free game. Each of the answer buttons indicated by five rectangular areas is provided in order to accept at least one of the answers indicative of five levels of evaluation or impression to each of the questions. When the previous page button A141 disposed at the upper right corner of the answer-to-questionnaire screen A140 has been depressed, the routine reverts to the answer-to-questionnaire A130 shown in FIG. 7B; and when the next page button A142 disposed at the right bottom corner has been depressed, the answer-to-question screen A150 shown in FIG. 8B is displayed.

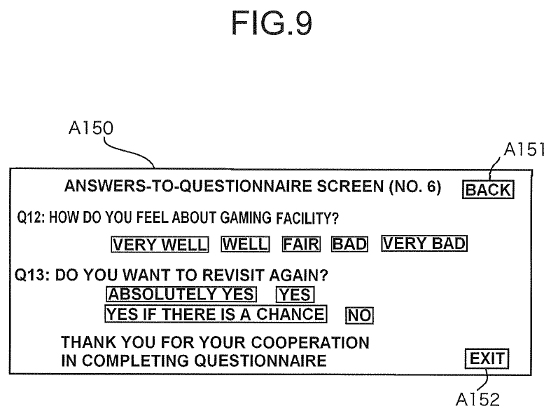

The answer-to-questionnaire screen A150 shown in FIG. 8B is displayed after changed from the answer-to-questionnaire screen A140 when the next page button A142 of the answer-to-questionnaire screen A140 shown in FIG. 8A has been depressed. This questionnaire screen A150 displays question Q10 asking evaluation relative to an effect image of a free game and question Q11 asking evaluation relative to effect music of the free game. Answer buttons indicated by five rectangular areas, respectively, are provided in order to accept candidates for answer indicative of five levels of evaluation to each of the questions. When a previous page button A151 disposed at the upper right corner of the answer-to-questionnaire screen A150 has been depressed, the routine reverts to the answer-to-questionnaire screen A140 shown in FIG. 8A. Alternatively, when a next page button A152 disposed at the lower right corner thereof has been depressed, an answer-to-questionnaire screen A160 shown in FIG. 9 is displayed.

The answer-to-questionnaire screen A160 shown in FIG. 9 is displayed after changed from the answer-to-questionnaire screen A150 when the next page button A152 has been depressed from the answer-to-questionnaire screen A150 shown in FIG. 8B. This questionnaire screen A160 displays question Q12 asking evaluation relative to a gaming facility and question Q13 asking possibility of revisit. Answer buttons indicated by five rectangular areas are provided in order to accept at least one of the answers indicative of five levels of evaluation to question Q12. Further, answer buttons indicated by four rectangular areas are provided in order to accept at least one of the answers indicative of four possibilities of revisit to question Q13. When the previous page button A161 disposed at the upper right corner of an answer-to-questionnaire screen A160 has been depressed, the routine reverts to the answer-to-questionnaire screen A150 shown in FIG. 8B. Alternatively, when an exit button A162 disposed at the lower right corner thereof has been depressed, answers input through the answer-to-questionnaire screens A110 to A160 are transmitted to the counting server 200 through the communication interface 44, together with gaming facility numbers, gaming machine ID numbers, and player identification information (if input) together with an answering time.

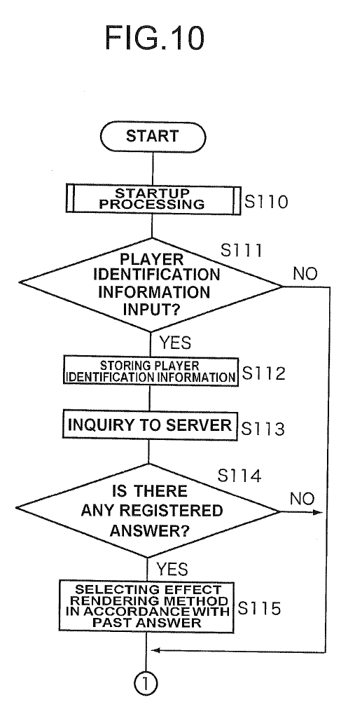

Hereinafter, operational procedures executed by a gaming machine 10 will be described. FIG. 10 is a flowchart showing procedures for executing a main process in the gaming machine 10. First, a startup process is performed in the gaming machine 10 (step S110). The startup processing will be described later in detail. While this main routine is executed, upon the receipt of a detection signal output from a coin counter 21C when the counter has detected coins, the main CPU 41 performs a process of adding the amount of credits stored in the RAM 43 as an interruption process.

Following the startup process, the main CPU 41 of the gaming machine 10 judges whether or not player information has been input (step S111). Player identification information is input by reading data for identifying players from a smart card inserted into a card reader 36. If it is judged that no player identification information is input (S111: NO), the main CPU 41 controls the routine to transfer to step S116 to be described later.

Where it is judged that player identification information is input (S111: YES), the input player identification information is stored in the RAM 43. Further, inquiry to the counting server 200 is performed based on the input player identification information (step S113), and it is judged whether or not there exists any answer that has been registered in the counting server 200 (step S114). If it is judged that no answer has been registered in the counting server 200 (S114: NO), the main CPU 41 controls the routine to transfer to step S116 to be described later.

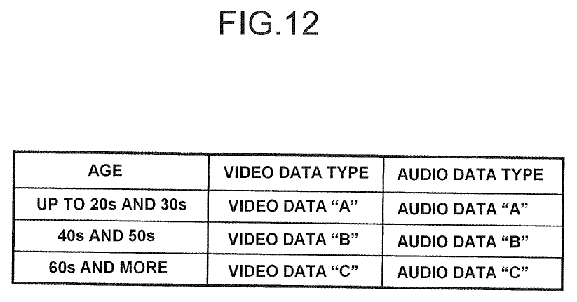

Further, where it is judged that there exists an answer registered in the counting server 200 (S114: YES), a game effect rendering method is selected according to the past answer (step S115). For example, video data and audio data employed for effect rendering according to the player's age is provided, and thereafter, video data and audio data is selected based upon information pertinent to the corresponding player's age, which is registered in the counting server 200. FIG. 12 is a tabulated view showing a relationship between the player's age and video data and audio data to be selected. In the example of FIG. 12, for instance, when the player's age is 20s or less or is 30s, it is shown that video data “A” and audio data “A” are reproduced at the time of game effect rendering. Video data and audio data may be provided by generation, or alternatively, plural types of video data and audio data are provided by generation so that video data and audio data reproduced when they are selected by the gaming machine 10 may be randomly determined.

While, in the abovementioned example, an effect rendering method was selected according to the player's age, it may be selected according to the player's gender or occupation. Further, the effect rendering method may be selected based upon the player's evaluation or impression, or alternatively, it may be selected according to a visit history (game history). In this case, it is possible to maintain the current effect rendering method when evaluation and satisfaction relative to an effect are high or conversely to vary the effect rendering method when such evaluation and satisfaction are low. Further, when a frequency of visit is high, generally used video data and audio data are converted to special video data and audio data so as to differentiate one player from another player.

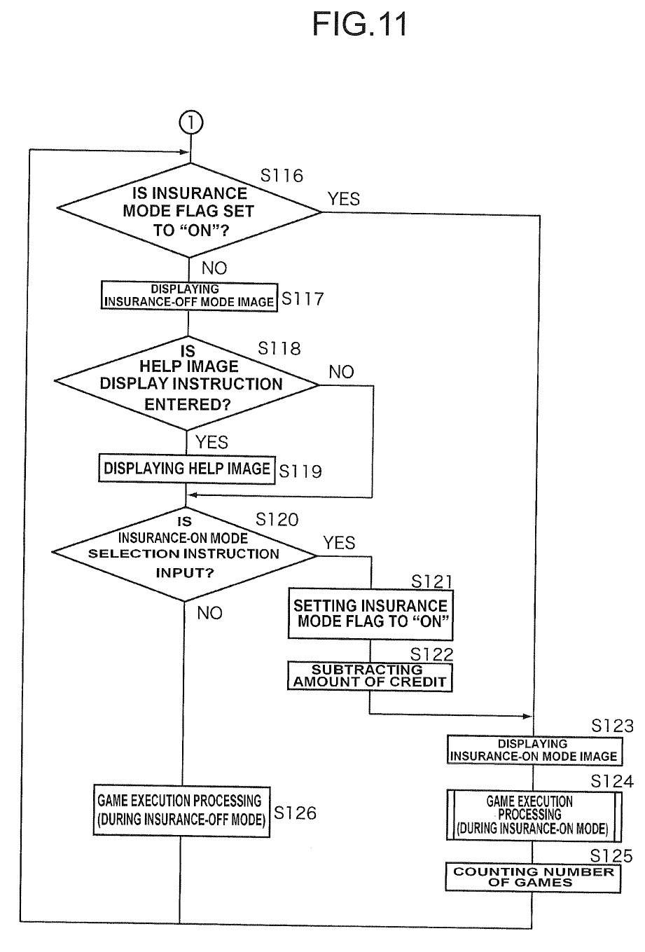

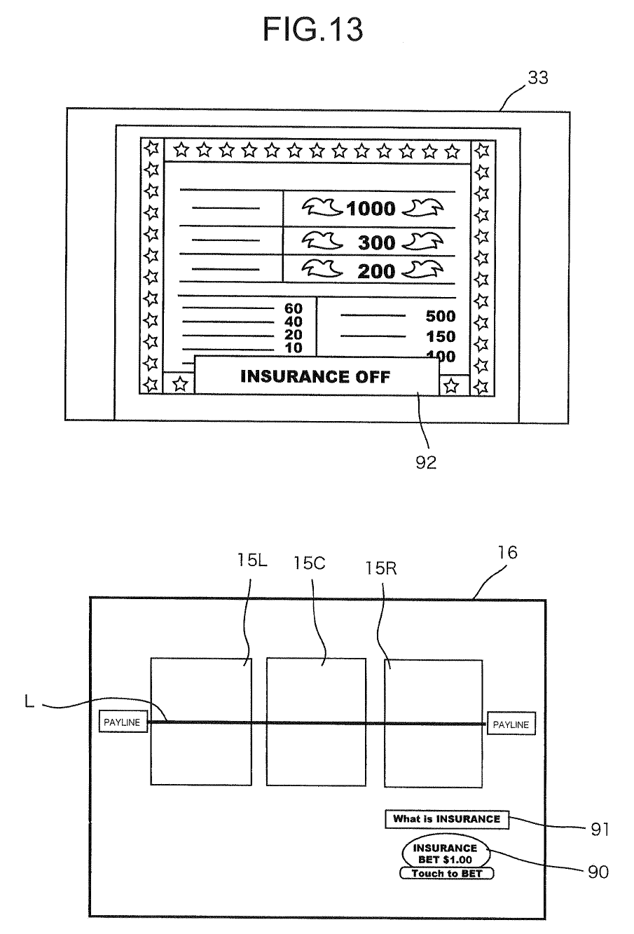

If it is judged that player identification information is not input at step S111 (S111: NO), if it is judged that no answer has been registered at S114 (S114: NO), or alternatively, if the effect rendering method has been selected at step S115, the routine proceeds to step S116 shown in FIG. 11. At step S116, the main CPU 41 judges whether or not an insurance mode flag stored in the RAM 43 has been set to “ON” (step S116). If it is judged that the insurance mode flag has not been to “ON”, i.e., if it is judged that the insurance mode flag has been set to “OFF” (S116: NO), a process of displaying an insurance-off mode image is performed (step S117). In this processing operation, the main CPU 41 transmits an instruction for graphically plotting insurance-off mode images to a graphic board 68. On a graphic board 68, based upon the above graphic display command, a VDP samples video data from the RAM 43, decompresses it to a video RAM, generates video data for one frame, and outputs the video data to upper and lower image display panels 33 and 16. As a result thereof, the upper and lower image display panels 33 and 16 display the images as shown in FIG. 13, for example.

FIG. 13 is a view showing exemplary images displayed on the upper and lower image display panels in the insurance-off mode. In the figure, reference numerals 15 (15L, 15C, 15R) denote display windows. Reference numeral 31 denotes a credit amount display section. Reference numeral 32 denotes a payout number display section. Uppercase letter L denotes a payline. An image 90, which is indicative of “INSURANCE BET S1.00 TOUCH TO BET,” is displayed at the lower right part of the lower image display panel 16. The image 90 is intended for prompting players to insert gaming mediums required to select an insurance-on mode. A player can enter an instruction for selecting an insurance-on mode, by touching a predetermined site of a touch panel 69 corresponding to a display area of the image 90.

In order to select the insurance-on mode, a predetermined amount of credit (1 dollar in the embodiment) is required. In place of the amount of credit, bills or coins equivalent thereto may be inserted. If the instruction for selecting the insurance-on mode has not been entered, the insurance-off mode is selected.

Upwardly of the image 90, an image which is indicative of “WHAT IS INSURANCE?” is displayed. The image 91 is intended for entering an instruction for displaying a help image. A player can enter the instruction for displaying the held image 91, by touching the predetermined site of the touch panel 69 corresponding to the display area of the help image. An image 92, which is indicative of “INSURANCE OFF,” is displayed at the lower part of the upper image display panel 33. The image 92 is indicative of the fact that the game mode is an insurance-off mode.

Following the process at step S117, the main CPU 41 judges whether or not an instruction for displaying a help image has been input (step S118). The instruction for displaying the help image is entered when the player touches the predetermined site of the touch panel 69 corresponding to the display area of the image 91, as described above.

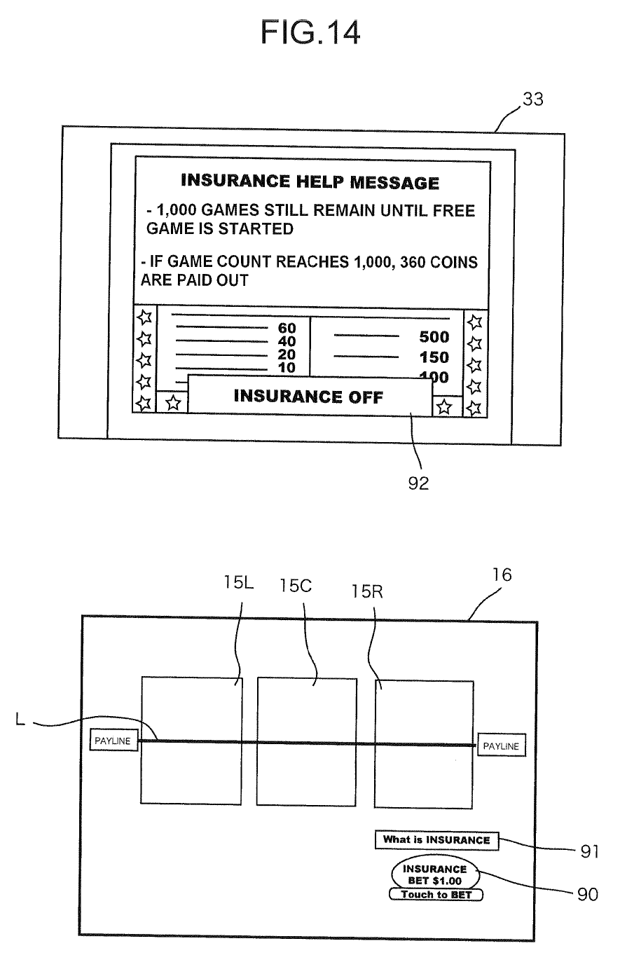

When an instruction for displaying a help image has been entered, a process of displaying the help image is performed (step S119). In this process, the main CPU 41 transmits a command for displaying the help image to a graphic board 68. The graphic board 68 performs a process of displaying images on the upper and lower image display panels 33 and 16. As a result thereof, the upper and lower image display panels 33 and 16 display the images as shown in FIG. 14, for example.

FIG. 14 is a view showing exemplary images displayed on the upper and lower image display panels in the insurance-off mode. The images that are displayed on these image display panels are substantially identical to those shown in FIG. 13, and are different therefrom in that a help image 93 is displayed at the upper part of the upper image display panel 33. The help image 93 is an explanatory image of: (a) the number of times of executing games until a free game (rescue pay) is started; and (b) the number of coins (360) paid when the number of times of executing games has reached a specific value. The help image 93 indicates an explanatory statement of the insurance-on mode. The help image 93 shown in FIG. 14 disappears when a predetermined period of time (10 seconds, for example) has elapsed after displayed.

When the process at step S119 has been executed or when the instruction for displaying the help image has been entered at step S118, the main CPU 41 judges whether or not the instruction for selecting an insurance-on mode has been entered (step S120). The instruction for selecting the insurance-on mode is entered when the player touches the predetermined site of the touch panel 69 corresponding to the display area of the image 90, as described above.

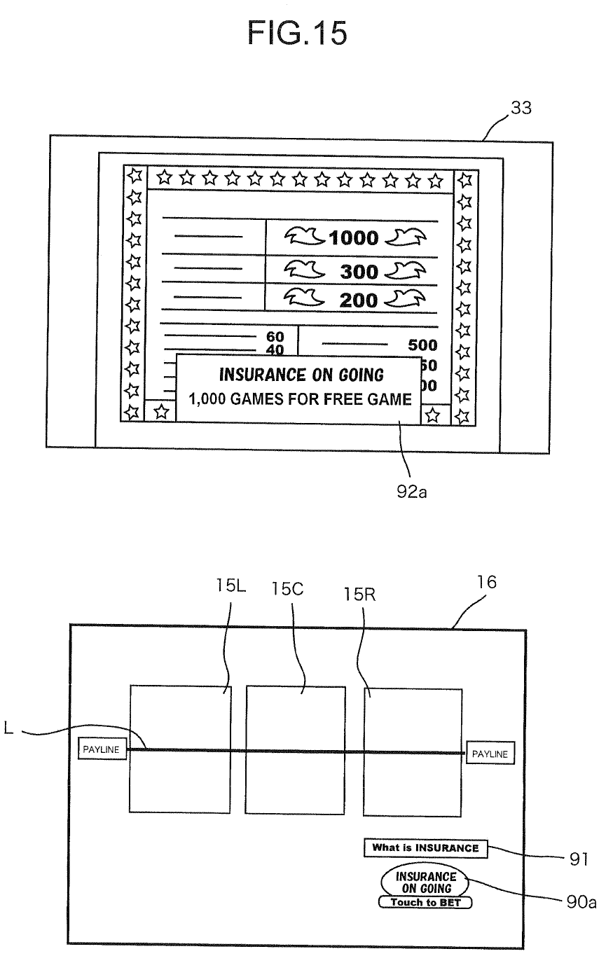

When the instruction for selecting the insurance-on mode has been entered, the main CPU 41 sets to “ON” the insurance mode flag stored in the RAM 43 (step S121). Subsequently, the main CPU 41 performs a process of subtracting a predetermined number (the amount of credit equivalent to one dollar in the embodiment) from the amount of credit stored in the RAM 43 (step S122).

Where it is judged that the insurance mode flag has been set to “ON” at step S116 or when the process at step S122 has been executed, a process for displaying the insurance-on mode image is performed (step S123). In this processing operation, the main CPU 41 transmits a command for graphically drawing the insurance-on mode image to the graphic board 68. On the graphic board 68, based upon the above graphic display command, the VDP samples video data from the RAM 43 (storage device) and decompresses the sampled data to the video RAM. Then, this VDP generates video data for one frame, and then, outputs the video data to the upper and lower image display panels 33 and 16. As a result thereof, the upper and lower image display panels 33 and 16 display the images as shown in FIG. 15, for example.

FIG. 15 is a view showing exemplary images displayed on the upper and lower image display panels in the insurance-on mode. At the lower right part of the lower image display panel 16, an image 90a, which is indicative of “INSURANCE IS ONGOING! TOUCH TO SEE HELP,” is displayed in place of the image 90 (see FIG. 13). The image 90a is indicative of the fact that the game mode is the insurance-on mode, and is intended to enter the instruction for displaying the help image. The player can enter the instruction for displaying the help image by touching the predetermined site of the touch panel 69 corresponding to the display area of the image 90a. At the lower part of the upper image display panel 33, an image 92a is displayed which is indicative of “INSURANCE IS ONGOING! 1,000 TIMES STILL REMAIN UNTIL FREE GAME IS STARTED”. The image 92a is indicative of the fact that the game mode is the insurance-on mode.

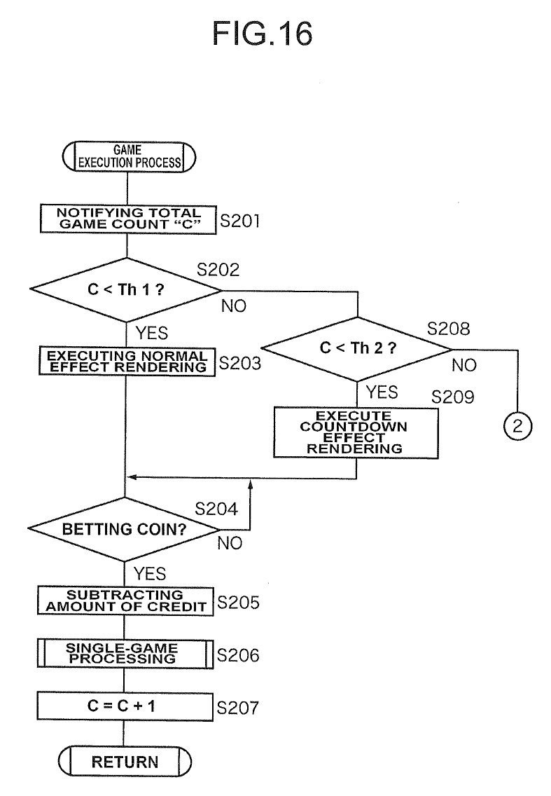

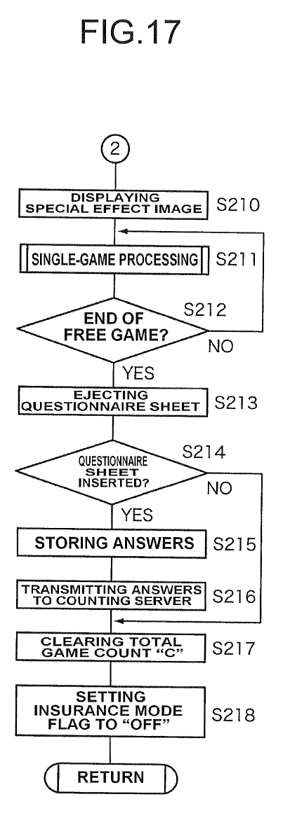

Following the process at step S123, the main CPU 41 performs a game execution process while in an insurance-on mode (step S124). This process will be described in detail, referring to FIGS. 16 and 17. After the game execution process while in the insurance-on mode has been completed, the counted number of games is incremented by one (step S125).

If the instruction for selecting the insurance-on mode has not been entered at step S120, the main CPU 41 performs a game execution process while in the insurance-on mode (step S126). This process is substantially identical to that while in the insurance-on mode, and thus, a duplicate description is omitted here. During the insurance-off mode, an image 92 is displayed on the upper image display panel 33, and images 90, 91 are displayed on the lower image display panel 16. When the process at step S125 or S126 has been executed, the routine is then reverted to step S116.

While the embodiment described a case in which the upper and lower image display panels 33 and 16 display the images 90a, 92a for notifying a transfer to the insurance-on mode, a sound for notifying the transfer to the insurance-on mode may be output from the speaker 29, in the present invention.

Next, a game execution process performed during the insurance-on mode read at step S124 in the main routine shown in FIG. 11 will be described. FIGS. 16 and 17 are flowcharts showing procedures for performing the game execution process while in the insurance-on mode. First, the main CPU 41, together with the ID number assigned thereto, notifies the current total game count C to a common display device 200, through a communication interface 44 (step S201).

Subsequently, the main CPU 41 judges whether or not the current total game count C is less than the abovementioned first predetermined value Th1 (990 in the embodiment) (step S202). Where it is judged that the current total game count C is less than a first predetermined value Th1 (S202: NO), normal effect rendering is performed (step S203). In this process, the main CPU 41 transmits to the graphic board 68 a command for displaying the video image selected at step S15 in the main routine. On the graphic board 68, based upon the abovementioned graphics-drawing command, the VDP samples video data from the RAM 43; decompresses the sampled data on the video RAM; generates video data for one frame; and then, outputs the video data to the lower image display panel 16. As a result thereof, the lower image display panel 16 displays a normal effect image. Further, the music selected at step S115 in the main routine is output through the speaker 29. This normal effect is different from a countdown effect rendered when transfer to a free game is oncoming, and serves as effect image or effect music for augmenting a base game.

Next, it is judged whether or not coins are betted (step S204). In this processing operation, the main CPU 41 judges whether or not an input signal output from a 1-BET switch 26S when a 1-BET button 26 is operated or that output from a MAX-BET switch 27S when a MAX-BET button 27 is operated has been received. Where it is judged that no coins are betted (S204: NO), the routine reverts to step S204.

Where it is judged that coins are betted at step S204 (S204: YES), the main CPU 41 performs processing of subtracting the credit amount stored in the RAM 43, in accordance with the number of betted coins (step S205). If the number of coins to be betted is greater than the credit amount stored in the RAM 43, this CPU does not perform the subtraction processing, and the routine reverts to step S204.

Subsequently, the main CPU 41 executes single-game processing to be described later (step S206). Procedures for performing the single-game processing will be described later. A game is executed in which, while it is triggered that the SPIN button 23 is set to ON by the player, rotational control of the reels 14 and processing of determining symbols to be stopped are performed, and a payment is made in accordance with stopped symbols or a combination thereof. After this single-game processing has completed, the main CPU 41 increments, by 1, the value of total game count C to be stored in the RAM 42 (step S207). After that, the current step reverts to the main routine shown in FIG. 9.

Where it is judged that the current total game count C is not smaller than the first predetermined value Th1 (S202: NO), the main CPU 41 judges whether or not the current total game count C is smaller than the second predetermined value Th2 (1,000 in the embodiment) (step 5208). Where it is judged that the current total game count C is a predetermined value Th1 or more, or alternatively, is less than a second predetermined value Th2 (S208: YES), countdown effect rendering is performed (step S209). In this process, the main CPU 41 transmits the graphic board 68 a command for displaying the video image selected at step S115 in the main routine. On the graphic board 68, based upon the above display command, the VDP samples video data from the RAM 43, and then, decompresses the sampled data to the video RAM. Further, this VDP generates video data for one frame, and then, outputs the generated data to the upper image display panel 33. As a result, a countdown effect image is displayed on the upper image display panel 33. Further, the music selected at step S115 in the main routine is output through the speaker 29. After that, the routine reverts to the abovementioned step S204, and a base game is then performed.

Where it is judged that the current total game count C has reached the second predetermined value Th2 at step S208 (S208: NO), the free game as described above is started. At this time, free game effect rendering is performed by displaying: an image indicating that a predetermined number of coins (360 coins in the embodiment) are paid out as a rescue pay because the total game count C has reached the second predetermined value Th2; and an image indicating the remaining count for a free game (step S210). In this process, the main CPU 41 transmits to the graphic board 68 a command for displaying the video image selected at step S115 in the main routine. On the graphic board 68, based upon the above display command, the VDP samples video data from the RAM 43, and then, compresses the sampled data to the video RAM. Further, this VDP generates video data for one frame, and outputs the video data to the upper image display panel 33. As a result, a free game effect image is displayed on the upper image display panel 33. Further, the music selected at step S115 in the main routine is output through the speaker 29.

Next, the single game processing to be described later is executed (step S211). Procedures for performing the single-game processing will be described later. A game is executed in which, while it is triggered that the SPIN button 23 is set to ON by the player, rotational control of the reels 14 and a process of determining symbols to be stopped are performed, and a payment is made in accordance with stopped symbols or a combination thereof.

The main CPU 41 judges whether or not to terminate a free game by judging whether or not the number of times of executing the single-game processing at step S211 performed as a free game has reached a predetermined number of times (step S212). Where it is judged that a free game is not terminated (S212: NO), the routine reverts to S211.

Where it is judged that a free game is terminated (S212: YES), a questionnaire screen shown in FIG. 1 (questionnaire request screen A100) is displayed on the lower image display panel 16 (step S213). In this process, the main CPU 41 transmits to the graphic board 68 a command for displaying images stored for a questionnaire screen in advance in the ROM 42. On the graphic board 68, based upon the abovementioned graphics-drawing command, the VDP samples video data from the RAM 43; decompresses the sampled data on the video RAM; generates video data for one frame; and then, outputs the video data to the lower image display panel 16. As a result, a questionnaire request screen A100, as shown in FIG. 1, is displayed on the upper image display panel 16.

Next, it is judged whether or not a player has entered answer sheets, based upon the information input through the questionnaire request screen A100 and the answer-to-questionnaire screens A110 to A160, each of which is displayed on the lower image display panel 16 (step S214). After at least one answer button has been depressed on the answer-to-questionnaire screens A110 to A160, where an exit button A162 is depressed on the answer-to-questionnaire screen A160 on the last page, it is judged that a player has entered answer sheets (S214: YES). Then, the entered answers are stored in the RAM 42 (step S215). Further, the stored answers are transmitted to the counting server 200 together with game machine ID numbers, gaming facility numbers, player identification information (only if it is input), and date and time of answer (step S216).

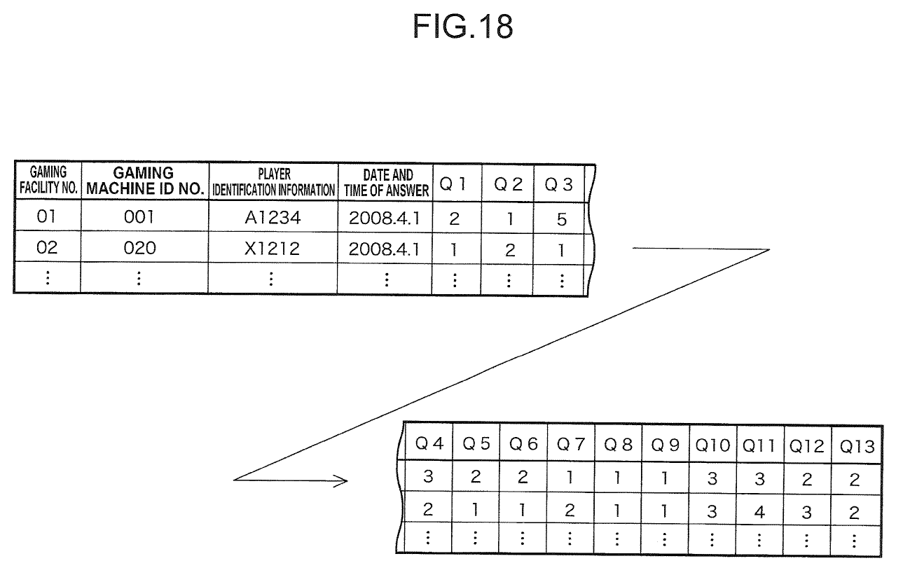

FIG. 18 is a schematic view showing an exemplary counting database included in the counting server 200. The counting database shown in FIG. 18 is provided in a hard disk drive 206 of the counting server, and is constituted to update data upon the receipt of the answers from each gaming machine 10 and information associated therewith. This counting database is stored while gaming machine ID numbers, gaming facility numbers, player identification information, date and time of answer, and the answers from players are associated with each other. The answers to questions Q1 to Q13 are stored in a digitized manner. For example, when an answer to gender is “male”, 1 is stored, or alternatively, when it is “female”, 2 is stored.

Where it is judged that no answers have been entered at step S214 (S214: NO), i.e., where an answer reject button A102 has been depressed on the answer request screen A100 shown in FIG. 1, or alternatively, where an exit button A162 has been depressed without entry of answers to questions on the answer-to-questionnaire screens A110 to A160, the total game count C stored in the RAM 42 is cleared (step S217). The insurance mode flag is set to OFF (step S218). After that, the current step reverts to the main routine shown in FIG. 9.

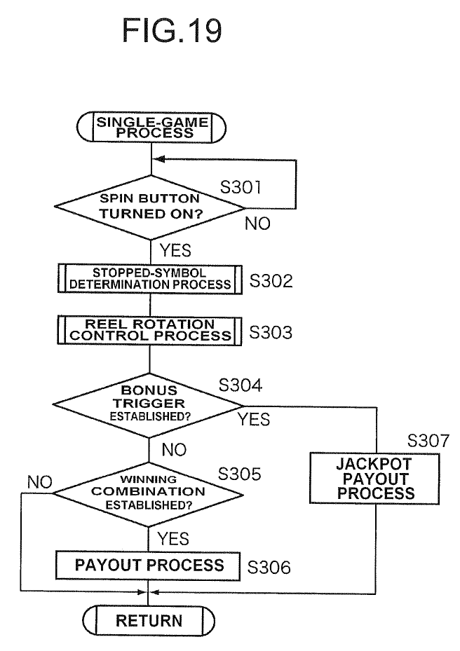

Next, the single-game processing invoked at steps S206 and S211 in the subroutines shown in FIGS. 16 and 17 will be described. FIG. 19 is a flowchart showing procedures for executing single-game processing. First, the main CPU 41 judges whether or not the SPIN button 23 has been set to ON (step S301). In this processing operation, the main CPU 41 judges whether or not the input signal output from the SPIN switch 23S has been received when the SPIN button 23 has been depressed. Where it is judged that the SPIN button 23 has not been set to ON (step S310: NO), the routine reverts to step S301. If the SPIN button 23 has not been set to ON (for example, if an instruction for terminating a game without turning ON the SPIN button 23 is entered), the main CPU 41 cancels a subtraction result at step S205.

While the present embodiment describes a case of performing a process of subtracting the credit amount before judging whether or not the SPIN button 23 has been set to ON after coins have been betted, the present invention is not limitative thereto. For example, it may be a routine to perform processing of judging whether or not the SPIN button 23 has been set to ON after coins have been betted, and then, subtracting the credit amount in the case where the judgment result is affirmative.

Where it is judged that the SPIN button 23 has been set to ON at step S301 (S301: YES), the main CPU 41 performs stopped-symbol determination processing (step S302). In this stopped-symbol determination process, the main CPU 41 determines code Nos. at the time of stoppage of reels 14, by executing a stopped-symbol determination program stored in the RAM 43. In this manner, a combination of the symbols displayed in a stopped state is determined. A detailed description thereof will be given later.

While the present embodiment describes a case of determining one winning combination from among plural kinds of winning combinations by determining a combination of symbols displayed in a stopped state, for example, in the present invention, it may be a routine to determine one winning combination randomly selected from among plural kinds of winning combinations with the use of random number values, and thereafter, determine the combination of the symbols displayed in a stopped state, based upon the abovementioned winning combination.

Next, the main CPU 41 performs reel rotation control processing (step S303). This processing operation is intended to stop rotation of each reel, so that a combination of specific symbols corresponding to the winning combination determined at step S302 is displayed in a stopped state on the payline L after rotation of all of the reels 14 is started. A detailed description thereof will be given later.

Next, the main CPU 41 judges whether or not a bonus game trigger has been established (step S304). If the judgment result is affirmative (S304: YES), any one jackpot is selected from among four different types of jackpots “GRAND”, “MAJOR”, “MINOR”, and “MINI” with the use of random number values, and a predetermined number of coins for such jackpot are paid out (step S307). Where coins are reserved, the main CPU 41 performs a process of summing the amount of credit stored in the RAM 43. Where coins are paid out, the main CPU 41 transmits a control signal to a hopper 66, and pays out a predetermined number of coins. At that time, a coin detection section 67 counts the number of coins paid out from the hopper 66, and then, transmits a payout completion signal to the main CPU 41 when the counted value has reached a specified number. In this manner, the main CPU 41 stops driving the hopper 66, and then, terminates coin payout processing.

If no bonus game trigger is established at step S304 (S304: NO), the main CPU 41 judges whether or not a winning combination is realized (step S305). If the judgment result is affirmative (S305: YES), the main CPU 41 pays out coins according to the number of inserted coins and the realized winning combination (step S306). Where it is judged that no winning combination is realized at step 305, or alternatively, if the processing at step S306 or S307 is executed, the main CPU 41 terminates this subroutine.

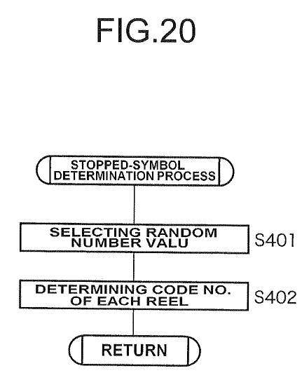

Next, a stopped-symbol determination process invoked at step S302 in the subroutine shown in FIG. 19 will be described. FIG. 20 is a flowchart showing procedures for determining symbols to be stopped. This process is performed by the main CPU 41 executing the stopped-symbol determination process stored in the RAM 43. First, the main CPU 41 selects a random number value corresponding to each of three reels 14 from among the numeric range of 0 to 255 (step S401). The present embodiment describes a case of generating random numbers in a programmable fashion (a case of using so called software random numbers). In the present invention, however, a random number generator is provided, whereby random numbers may be sampled from the random number generator (so called hardware random numbers may be used).

Next, the main CPU 41 (processor) refers to symbol-weighted data according to the payout rate setting data that is output from the GAL 54 and stored in the RAM 43 (storage device), and then, determines code No. (see FIG. 3) of each of the reels 14, based upon the selected three random number values (step S402). Code Nos. of the reels 14 correspond to those of symbols displayed in a stopped state on the winning line L. A reel rotation control process, which is to be described later, is performed based upon code Nos. of the reels 14.

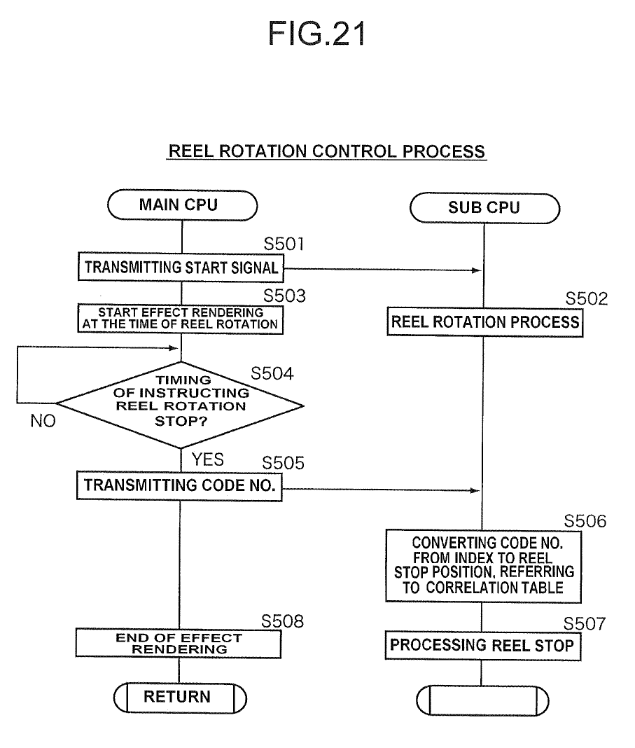

Next, the reels rotation control process invoked at step S303 in the subroutine shown in FIG. 19 will be described. FIG. 21 is a flowchart showing procedures for executing reel rotation control processing. This processing operation is performed between the main CPU 41 and a sub CPU 61.

First, the main CPU 41 transmits to the sub CPU 61 a start signal for storing reel rotation (step S501). Upon the receipt of the start signal from the main CPU 41, the sub CPU 61 performs reel rotation processing (step S502). In this process, the sub CPU 61 supplies pulses to a motor driving circuit 62. The pulses output from the sub CPU 61 are amplified by means of a driver 64, and the amplified pulses are then supplied to stepping motors 70 (70L, 70C, 70R). As a result thereof, each of the stepping motors 70 rotates, and concurrently, each of the reels 14 (14L, 14C, 14R) rotates. Each of the stepping motors 70 of the 1-2 phase excitation system has a stepping angle of 0.9 degrees and 400 steps per rotation. Therefore, if 400 pulses are supplied to the stepping motors 70, the reels 14 make one rotation.

At the time of starting rotation of the reels 14, the sub CPU 206 supplies pulses with low frequencies to the motor driving circuit 62. After that, this sub CPU gradually increases the frequencies of the pulses. Concurrently, the rotation speed of each of the reels 14 increases. When a predetermined time has elapsed, the frequencies of the pulses are made uniform. As a result thereof, each of the reels 14 rotates at a constant speed.

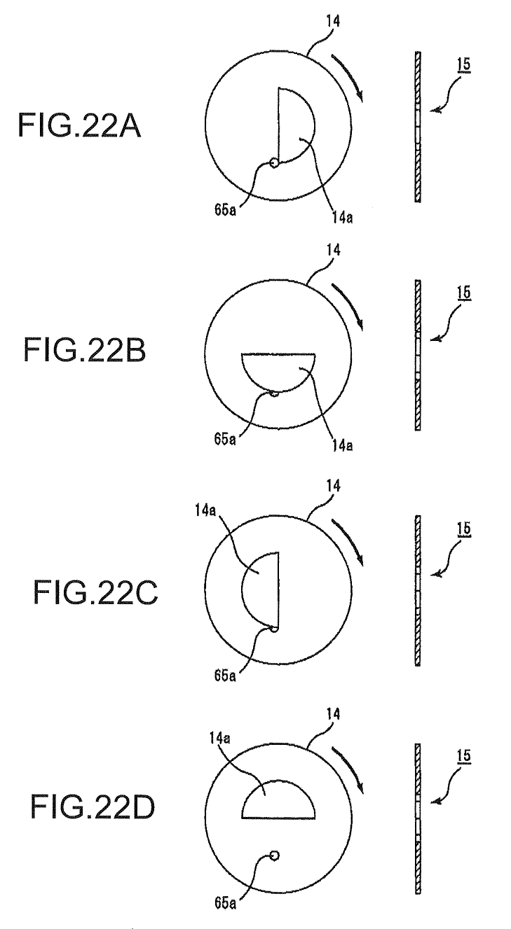

Hereinafter, a rotating movement of the reels 14 will be described, referring to FIGS. 22A to 22D. These figures are explanatory side views of the rotating movement of the reels 14. As shown in FIG. 22A, a semicircular metal plate 14a is provided on the side face of each of the reels 14. The metal plate 14a rotates with each of the reels 14. Further, 22 symbols are provided on the peripheral face of each of the reels 14. Three of the 22 symbols drawn on the peripheral face of each of the reels 14 can be visually recognized via a display window 15 formed ahead of each of the reels 14. The heavy-line arrow in the figure indicates the rotational direction of each of the reels 14. Further, a proximity sensor 65a is provided laterally of each of the reels 14. The proximity sensor 65a is intended to detect a metal plate 14a. The proximity sensor 65a neither moves nor rotates, even if each of the reels 14 rotates.

FIG. 22A shows a position (hereinafter, referred to as position A) of the metal plate 14a when the plate is about to be detected by means of the proximity sensor 65a. If the reels 14 rotate when the metal plate 14a is set at position A, the metal plate 14a moves to the position shown in FIG. 22B. FIG. 22B shows a position (hereinafter, referred to as position B) of the metal plate 14a when the plate is detected by means of the proximity sensor 65a. If the reels 14 rotate when the metal plate 14a is set at position B, the metal plate 14a moves to the position shown in FIG. 22C. FIG. 22C shows a position (hereinafter, referred to as position C) of the metal plate 14a when the plate is not detected by means of the proximity sensor 65a.

If the reels 14 rotate when the metal plate 14a is set at position C, the metal plate 14a moves to the position shown in FIG. 22D. FIG. 22D shows a position (hereinafter, referred to as position D) of the metal plate 14a when the plate is not detected by means of the proximity sensor 65a. If the reels 14 further rotate, the metal plate 14a reverts to the position A. As described above, the plate 14a is sequentially shifted to positions A, B, C, D, and then, to A, together with rotation of the reels 14.

The proximity sensor 65a constitutes an index detection circuit 65 (see FIG. 5). Assuming that a state in which the proximity sensor 65a is detecting the metal plate 14a is established at “High” and a state in which such detection is not being performed is established at “Low”, when the metal plate 14a is shifted to the positions C, D, and then, to A, the state of the index detection circuit 65 is established at “Low”. The sub CPU 61 recognizes the rotational position of each of the reels 14 while a rising edge from “Low” to “High” is defined as an index (origin) 1 and a falling edge from “High” to “Low” is defined as an index (origin) 2.

The main CPU 40 executes effect rendering at the time of reel rotation after transmitting a start signal to the sub CPU 61 at step S40 (step S503). This processing operation is intended to display an image on the lower image display panel 16 or outputs a sound from the speaker 29, over a period of time (3 seconds, for example) which is determined responsive to a result of the abovementioned stopped-symbol determination processing, etc.

Next, the main CPU 40 judges whether or not a timing of instructing rotation stop of the reels 14 is established (step S504). The timing of instructing rotation stoppage of the reels 14 is equivalent to that which is precedent by time minimally required to stop rotation of the reels 14 at a time point of terminating effect rendering performed at the time of reel rotation. The minimally required time for stopping rotation of the reels 14 is predetermined.

Where the judgment result at step S504 is negative (S504: NO), the routine restarts from the same step at which the effect rendering at the time of reel rotation is continuously provided. Where the result is affirmative (S504: YES), the main CPU 41 transmits, to the sub CPU 61, code Nos. of the reels which were stored in the RAM 43 (step S505). Upon the receipt of code Nos. of reels from the main CPU 41, the sub CPU 61 converts the code Nos. to the stop positions of reels from index (step Nos.), based upon a correlation table between the number of steps and code Nos. stored in the ROM (not shown) included in the sub CPU 61 (step S506).

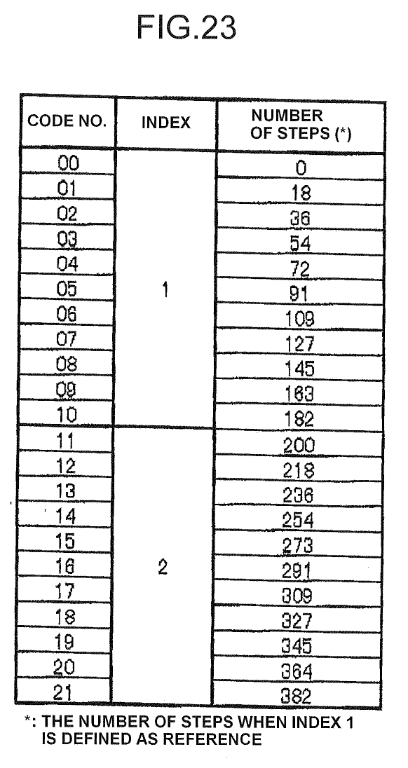

FIG. 23 is a schematic view showing a correlation table between the number of steps and code Nos. For code Nos. The corresponding indexes and the number of steps are associated with each other. Code Nos. correspond to the symbols drawn on the outer periphery of reels 14, and the symbols of code Nos. “00” to “10” correspond to index 1, and those of code Nos. The symbols of code Nos. 11 to 21 correspond to index 2. The number of steps in the correlation table shown in FIG. 23 is determined while index 1 is defined as a reference. For example, if code No. is “08”, 145 steps from index 1 are equivalent to reel stop positions. Further, if code No. is “12”, 218 steps from index 1 are equivalent to reel stop positions.

Next, the sub CPU 61 executes reel stop processing (step S507). In this processing operation, the sub CPU 61 detects, for each of the reels 14, a rising edge (index 1) from “Low” to “High” in the index detection circuit 65. This sub CPU then supplies to the motor driving circuit 65 the pulses which are equivalent to the number of steps converted from code Nos. at step S52, with a timing with which index 1 was detected. After that, the sub CPU stops supplying pulses.

For example, at step S506, if the reel stop position is determined to be 145 steps from index 1, the sub CPU 61 supplies 145 pulses to the motor driving circuit 65 with the timing with which index 1 was detected. After that, this sub CPU stops supplying pulses. Further, at step S52, if the reel stop position is determined to be 218 steps from index 1, the sub CPU 61 supplies 218 pulses to the motor driving circuit 65, with the timing with which index 1 was detected. As a result, the reels 14 stop in accordance with code No. determined at step S402 in FIG. 20, and a combination of symbols corresponding to the winning combination determined at step S402 in FIG. 20 is displayed in a stopped state. On the other hand, the main CPU 41 terminates effect rendering performed at the time of reel rotation (step S508). After terminating the processing operations at steps S507 and S508, the main CPU 41 terminates this processing operation.

If the index corresponding to code No., transmitted at step S505 is different from that detected by means of the index detection circuit 65 when rotation of the reels 14 has stopped, step-out of the reels 14 arises. Thus, the main CPU 41 performs processing, for example, of displaying an error message on the lower image display panel 16, and then, cancels a game. For example, this CPU cancels a game, if index 1 is detected by means of the index detection circuit 65 when rotation of the reel 14L has stopped in spite of the fact that the process of stopping the reel 14L with code No. 12 corresponding to index 2 was performed.

The present embodiment described a case of employing the mechanical reels 14. However, the present invention may employ an arrangement in which symbols are displayed on a display device such as a liquid crystal display device.

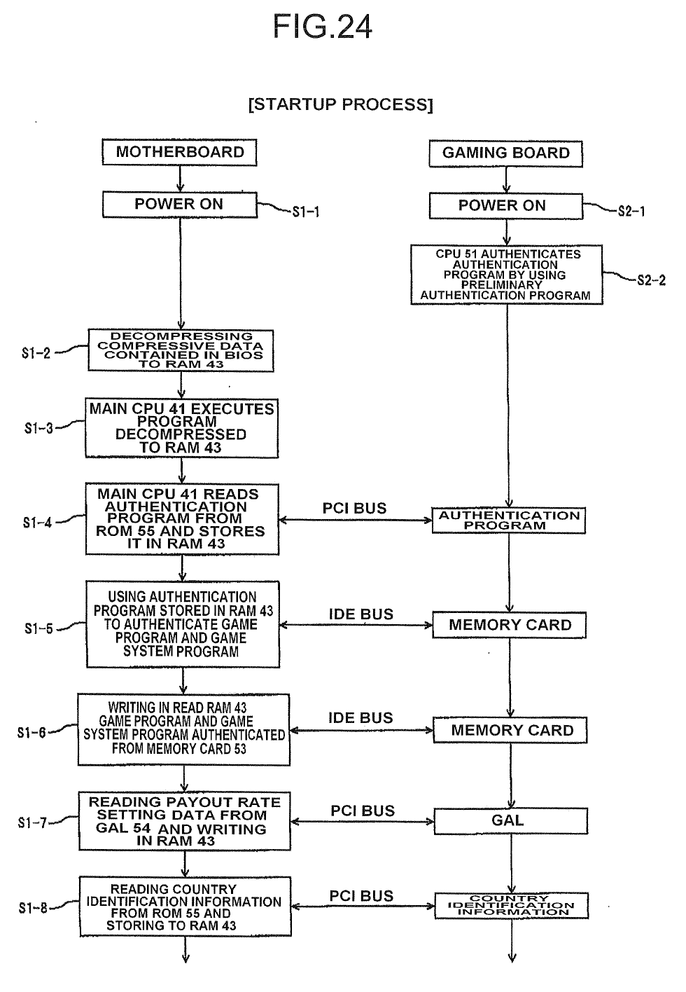

Lastly, startup processing, which is invoked at step S110 in the main routine shown in FIG. 10, will be described. FIG. 24 is a flowchart showing procedures for performing startup processing. This flowchart also shows procedures for performing an authentication reading process for a game program and a game system program with the use of the motherboard 40 and the gaming board 50. A memory card 53 is inserted into a card slot 53S provided in the gaming board 50, and a GAL 54 is mounted on an IC socket 54S.

When a power switch is turned ON (power is supplied) in a power unit 45, the motherboard 40 and the gaming board 50 are started up (steps S1-1, S2-1). When they are started up, individual processing operations are performed in parallel, respectively. That is, on the gaming board 50, the CPU 51 reads a preliminary authentication program stored in the boot ROM 52. In accordance with the read preliminary authentication program, this CPU performs preliminary authentication to verify and certify in advance that an authentication program is not falsified, before data capturing in the motherboard 40 (step S2-2). On the other hand, on the motherboard 40, the main CPU 41 executes a BIOS stored in the ROM 42, and then, decompresses in the RAM 43 the compressed data incorporated in the BIOS (step S1-2). After that, the main CPU 41 executes the BIOS decompressed in the RAM 43, and diagnoses and initializes various peripheries (step S1-3).

To the main CPU 41, a ROM 55 of the gaming board 50 is connected via a PCI bus. The main CPU 41 performs processing of reading the authentication program stored in the ROM 55 and storing the read authentication program in the RAM 43 (step S1-4). At this time, the main CPU 41 takes a check sum by means of an ADDSUM system (standard check function) in accordance with the standard BIOS functions, and then, causes the RAM 43 to store the authentication program, while performing a process of verifying whether or not storing operation is reliably performed without any mistake.

Next, after checking what is connected to an IDE bus, the main CPU 41 accesses the memory card 53 inserted into the card slot 53S via the IDE bus, and then, reads a game program and a game system program from the memory card 53S. In this case, the main CPU 41 reads data constituting the game program and game system program on a four-by-four bytes basis. Subsequently, the main CPU 41 performs authentication to verify and certifies that the read game programs and game system programs are not falsified, in accordance with the authentication program stored in the RAM 43 (steps S1-5). When this authentication processing normally terminates, the main CPU 41 causes the RAM 43 to write and store the (authenticated) game programs and game system programs targeted for authentication (steps S1-6). Next, the main CPU 41 provides an access to the GAL 54 mounted to the IC socket 54S via the PCI bus; reads payout rate setting data; and causes the RAM 43 to write and store the data (steps S1-7). Next, the main CPU 41 performs processing of reading country ID information stored in the ROM 55 of the gaming board 50 and causing the RAM 43 to store the read country ID information (steps S1-8).

After performing such startup processing, the main CPU 41 sequentially reads and executes the game programs and game system programs, thereby conducting the abovementioned game.

As described above, questions to be answered are displayed which include the player's age, gender, impression or evaluation of a game, and impression or evaluation of gaming facility in which gaming machines 10 are installed. Further, the answers to these questions are obtained from players. In this manner, information pertinent to players such as the players' ages and genders and actual opinions of the players such as advantages or drawbacks of games felt by the players can be collected within a short period of time without making a market research for.

When answers are transmitted to the counting server 200, information is transmitted which includes gaming machine ID numbers for identifying gaming machines 10 and numbers of gaming facilities in which gaming machines 10 are installed. Thus, information pertinent to players by gaming facility and by gaming machine 10 and impression or evaluation and the like of games can be counted. The ability to attract customers can be improved more remarkably by replacing the gaming machines or changing the contents of games, based upon the result of the counting.

Further, images and music responsive to the players' answers are reproduced on the counting server 200 when a game is started. This makes it possible to reproduce images and music which are different depending upon the players' ages or genders and attract the players' interests or concerns.

The present embodiment described: a base game in which symbols are rearranged on a display device and a payment is made according to a combination of the rearranged symbols; and a free game executed without betting gaming mediums. However, the games executed in the gaming machines 10 are not limitative to such base game or free game. Any game different from that played at a slot machine may be performed. For example, card games such as poker or other games such as a shooting game or a martial art game may be performed. At this time, these games may be performed only once, or alternatively, may be repeatedly performed over a plurality of times.

Further, advantageous effects described in the embodiments of the present invention are merely exemplified as the most preferable effects derived from the present invention. The advantageous effects according to the present invention are not limitative to those described in the embodiments thereof.

What is claimed is:

1. A gaming machine, comprising:
a controller which executes a process of starting a game, as triggered by establishment of a predetermined condition;
a display device which displays a question to be answered;
an input device for inputting an answer to the question displayed on the display device; and
a memory which stores the answer input through the input device.

2. The gaming machine according to claim 1, further comprising:
a memory which stores plural types of video data and audio data; and
a reproduction device which reproduces video data and audio data selected according to the stored answer.

3. The gaming machine according to claim 1, further comprising a communication interface connected to a counting server which counts the answer to the question, wherein:
the communication interface transmits the answer input through the input device to the counting server together with identification information for identifying a transmission source.

4. The gaming machine according to claim 1, wherein:
the controller executes a process of counting the number of times of executing the game and a process of judging whether or not the counted number of executing the game has reached a predetermined value; and
the display device is capable of displaying a question to be answered, in a case where the controller judges that the number of times of executing the game has reached a predetermined value.

5. The gaming machine according to claim 4, wherein:
the controller executes a process of associating the answer input through the input device with a game history obtained until a question has been displayed on the display device, and then, storing the answer and game history in the memory.

6. The gaming machine according to claim 5, further comprising:
a memory which stores plural types of video data and audio data; and
a reproduction device which reproduces video data and audio data selected according to the stored answer and game history.

7. A gaming machine, comprising:
a controller which executes a process of starting a game as triggered by establishment of a predetermined condition, a process of counting the number of times of executing the game, and a process of judging whether or not the counted number of times of executing the game has reached a predetermined value;
a display device which is capable of displaying a question to be answered, in a case where the controller judges that the number of times of executing the game has reached a predetermined value;
an input device for inputting an answer to the question displayed on the display device;
a memory which stores the answer and game history input through the input device and plural types of video data and audio data; and
a reproduction device which reproduces video data and audio data selected according to the stored answer and game history.

8. A method of acquiring a player's answer to a question, comprising the steps of:
starting a game as triggered by establishment of a predetermined condition;
displaying a question to be answered, on a display device; and
storing in a memory the answer input through an input device in response to the displayed question.
